(19) United States
(12) Patent Application Publication
(10) Pub. No.: US 2011/0040746 A1
(43) Pub. Date: Feb. 17, 2011

(54) COMPUTER SYSTEM FOR PROCESSING STREAM DATA

(75) Inventors: Atsuro Handa, Yokohama (JP); Kazuho Tanaka, Fujisawa (JP); Satoru Watanabe, Yokohama (JP); Tomohiro Hanai, Tachikawa (JP); Kazunori Tamura, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/715,289

(22) Filed: Mar. 1, 2010

(30) Foreign Application Priority Data
Aug. 12, 2009 (JP) 2009-187129

(51) Int. Cl. G06F 17/30

(52) U.S. Cl. 707/721; 707/E17.131

(57) ABSTRACT

It is provided a computer system for processing stream data, in which queries that are set in advance are executed to output a result. The queries include a first query, a second query and a third query. The first query is executed to output a first intermediate result. The second query is executed to output a second intermediate result. The third query is executed with inputting the first intermediate result and the second intermediate result to output the result. The computer system extracts first contribution information including part of the first stream data contribute to the first intermediate result, extracts second contribution information including part of the first stream data contribute to the second intermediate result, extracts third contribution information including part of the first stream data contribute to the result, and holds relation between the result and the third contribution information.

### CLAIM OF PRIORITY

The present application claims priority from Japanese patent applications JP 2009-187129 filed on Aug. 12, 2009, the content of which are hereby incorporated by reference into this application.

### BACKGROUND OF THE INVENTION

This invention relates to a computer system for processing stream data, and more particularly, to a stream data processing system for analyzing what causes an event to occur in stream data processing.

In recent years, development of information and communication technologies has been accompanied by an exponential increase in amount of information data processed by an application.

In a conventional database management system (DBMS), received data is temporarily stored in a storage area of a database or the like, and then batch processing is performed by using the received data stored in the storage area. The storage of the received data in the database therefore causes a time lag. When the amount of data increases exponentially, an amount of calculation linearly increases. Hence, some applications may not be able to provide satisfactory processing performance demanded by clients.

In view of future development of information and communication technologies, it is essential to improve performance of the IT platform. Thus, a stream data processing system that enables real-time aggregation and analysis is attracting attention.

The stream data processing system targets stream data for calculation. The stream data refers to a data sequence that incessantly arrives in time series. For example, RFID read information, traffic information, or stock price information corresponds to stream data.

In the stream data processing system, data processing is performed according to a predefined scenario. The scenario uses the continuous query language (CQL) as disclosed in, for example, JP 2006-338432 A. The CQL is an extension of the structured query language (SQL) widely used in the DBMS. The CQL is used to write a scenario in the form of a query as in the case of the SQL. A query of the stream data processing system is different from that of the conventional SQL in the following points.

The first point is in that the scenario is constituted by a plurality of join queries. For example, as disclosed in JP 09-34759 A, the conventional SQL is used for processing that targets one input and one output, and the processing is constituted by a single query. JP 09-34759 A discloses an example of a specific SQL sentence.

On the other hand, in the stream data processing system, complex data processing that cannot be implemented by a single query can be performed. Specifically, a plurality of queries are joined to calculate an intermediate result, and hence complex processing can be performed.

The second point is introduction of a concept of a unique window. The stream data is data that continuously arrives without any breaks. Hence, to extract data of a calculation target, time-sequential data must be divided into bounded data aggregates. Thus, in the stream data processing system, a concept of a window (sliding window) is introduced, and difference calculation that targets a window change difference is employed.

Sliding windows are largely classified into two types which are specifically a window for holding n most recent pieces of input information (ROW window) and a window for holding an amount of input information falling within a range of the last n hours (RANGE window).

The use of those windows (e.g., use of the ROW window) enables aggregation and analysis of n most recent pieces of input information at a time close to the real time with respect to an arbitrary time.

The sliding window absent in the conventional database processing system is an operator unique to the stream data processing system. The sliding window is enabled by introducing the CQL.

It should be noted that a specific technology in which the CQL is used is disclosed in JP 2006-338432 A.

### SUMMARY OF THE INVENTION

An analysis scenario executed in the stream data processing system is complex data processing in which analytic processing is executed by using a plurality of pieces of input information and multi-dimensional parameters obtained by a plurality of queries.

Further, the unique window operator is introduced in the stream data processing system, and hence, as compared with the data processing of the conventional architecture, it is difficult to determine which input information is data of a calculation target with respect to results of the analysis scenario that are generated incessantly. Thus, in a case of investigating causes of the results of the analysis scenario, it is difficult to determine which input information or query has influenced the obtained results.

As compared with the conventional database system, there are three major reasons for the difficulty in causal analysis for results in the stream data processing system.

The first reason is as follows. In the stream data processing system, complex data processing is executed, in which an analysis is executed by using a plurality of pieces of input information and multi-dimensional parameters obtained by a plurality of queries, and further, results and intermediate results of the analysis scenario are generated incessantly. Thus, it is difficult to determine which input information contributed to the results and intermediate results of the analysis scenario.

The second reason is because a plurality of queries are joined together in the stream data processing system and it is thus necessary to determine causes with respect to the intermediate results of the queries, too.

The third reason is as follows. In the stream data processing system, a window operator unique to the stream data processing system is employed. Thus, unlike the causal analysis in the conventional database system, it is necessary to execute the causal analysis for results in consideration of processing of that window operator.

For the three reasons described above, the causes of results of the analysis scenario cannot be analyzed by the causal analysis method used in the conventional database system as described in JP 09-34759 A.

This invention has been made in view of the problems described above, and it is therefore an object of this invention to facilitate, in an analysis scenario executed in stream data processing, a causal analysis for a result of the analysis scenario.

A representative aspect of this invention is as follows. That is, there is provided a computer system for processing stream data, in which a plurality of queries that are set in advance are executed by using first stream data that arrives successively, to thereby output a result. The computer system comprises a stream data processing computer that comprises a processor and a memory connected to the processor and processes the first stream data. The first stream data includes a plurality of pieces of input information The plurality of queries includes a first query, a second query and a third query. Based on the first stream data, the first query is executed to output a first intermediate result, and the second query is executed to output a second intermediate result. The third query is executed with inputting the first intermediate result and the second intermediate result to output the result. The stream data processing system holds processing executed by the first query, the second query and the third query; extracts first contribution information including part of the first stream data contribute to the first intermediate result based on the first stream data and processing executed by the first query; extracts second contribution information including part of the first stream data contribute to the second intermediate result based on the first stream data and processing executed by the second query; extracts third contribution information including part of the first stream data contribute to the result based on the first contribution input information and the second contribution input information; and holds relation between the result and the third contribution information.

According to the aspect of this invention, it is possible to acquire the information that contributed to the result or intermediate result of an analysis executed in the stream data processing. Accordingly, the cause of the output result can be determined.

### BRIEF DESCRIPTION OF THE DRAWINGS

The present invention can be appreciated by the description which follows in conjunction with the following figures, wherein:

FIG. 1 is a block diagram illustrating an example of a configuration of a stream data processing system having a trace function according to a first embodiment of this invention;

FIG. 2 is an explanatory diagram illustrating an example of a join query model according to the first embodiment of this invention;

FIG. 3 is an explanatory diagram illustrating specific examples of input information and an analysis scenario according to the first embodiment of this invention;

FIG. 4 is an explanatory diagram illustrating examples of input information 1 and input information 2 according to the first embodiment of this invention;

FIG. 5 is an explanatory diagram illustrating examples of intermediate result 1 and intermediate result 2 according to the first embodiment of this invention;

FIG. 6 is a flow chart illustrating processing of the trace function that is provided to a stream data processing computer according to the first embodiment of this invention;

FIG. 7 is a flow chart illustrating processing executed by an aggregation/analysis module according to the first embodiment of this invention;

FIG. 8 is a flow chart illustrating processing executed by a contribution information extraction module according to the first embodiment of this invention;

FIG. 9 is an explanatory diagram illustrating an example of input and output of the contribution information extraction module in a query 2 according to the first embodiment of this invention;

FIG. 10 is an explanatory diagram illustrating an example of processing of extracting processing target data based on a window operator in the query 2, which is executed by the aggregation/analysis module according to the first embodiment of this invention;

FIG. 11 is an explanatory diagram illustrating an example of processing of extracting columns necessary to generate output from a processing target data in the query 2, which is executed by the aggregation/analysis module according to the first embodiment of this invention;

FIG. 12 is an explanatory diagram illustrating an example of processing of generating the output of the query 2, which is executed by the aggregation/analysis module according to the first embodiment of this invention;

FIG. 13 is an explanatory diagram illustrating an example of processing executed by a contribution information addition module in the query 2 according to the first embodiment of this invention;

FIG. 14 is an explanatory diagram illustrating an example of input and output of the contribution information extraction module in a query 3 according to the first embodiment of this invention;

FIG. 15 is an explanatory diagram illustrating an example of processing of extracting processing target data based on a window operator in the query 3, which is executed by the aggregation/ analysis module according to the first embodiment of this invention;

FIG. 16 is an explanatory diagram illustrating an example of processing executed by the contribution information extraction module in the query 3 according to the first embodiment of this invention;

FIG. 17 is an explanatory diagram illustrating an example of processing of generating output of the query 3, which is executed by the aggregation/analysis module according to the first embodiment of this invention;

FIG. 18 is an explanatory diagram illustrating an example of processing executed by the contribution information addition module in the query 3 according to the first embodiment of this invention;

FIG. 19 is an explanatory diagram illustrating an example of processing executed by a trace information holding module according to the first embodiment of this invention;

FIG. 20 is an explanatory diagram illustrating an example of processing executed by the contribution information removal module according to the first embodiment of this invention;

FIG. 21 is a block diagram illustrating a configuration of a stream data processing computer having a replay function according to a second embodiment of this invention;

FIG. 22 is a flow chart illustrating processing executed by the stream data processing computer in the case of normal operation according to the second embodiment of this invention;

FIG. 23 is a flow chart illustrating processing executed by the stream data processing computer in the case of causal analysis according to the second embodiment of this invention;

FIG. 24 is a flow chart illustrating an example of processing executed by the contribution information restoration module according to the second embodiment of this invention;

FIG. 25 is an explanatory diagram illustrating an example of information pieces output from the aggregation/analysis module to the reproduced information acquisition module according to the second embodiment of this invention;

FIG. 26 is an explanatory diagram illustrating an example of information output from the CQL processing analysis module to the contribution information restoration module according to the second embodiment of this invention;

FIG. 27 is an explanatory diagram illustrating an example of processing of extracting an intermediate result of the query 1 and an intermediate result of the query 2 that contributed to a result, which is executed by the contribution information restoration module according to the second embodiment of this invention;

FIG. 28 is an explanatory diagram illustrating an example of processing of extracting input information that contributed to the intermediate result of the query 1, which is executed by the contribution information restoration module according to the second embodiment of this invention;

FIG. 29 is an explanatory diagram illustrating an example of processing of extracting input information that contributed to the intermediate result of the query 2, which is executed by the contribution information restoration module according to the second embodiment of this invention; and

FIG. 30 is an explanatory diagram illustrating an example of processing executed by the replay information holding module according to the second embodiment of this invention.

### DETAILED DESCRIPTION OF THE PREFERRED EMBODIMENTS

A stream data processing system according to this invention has two functions of a trace function and a replay function. First, the trace function is described.

### First Embodiment

In an analysis scenario constituted by one or more queries, in the trace function, input information that contributed to a result or intermediate result is acquired with respect to the result or intermediate result, which is obtained in the course of executing data processing in a plurality of queries after input information is input to a stream data processing system. Further, the acquired input information that contributed to the result or intermediate result is added to the result or intermediate result by linking that input information and the result or intermediate result to each other.

Accordingly, input information that contributed to a result or intermediate result can be provided to a client.

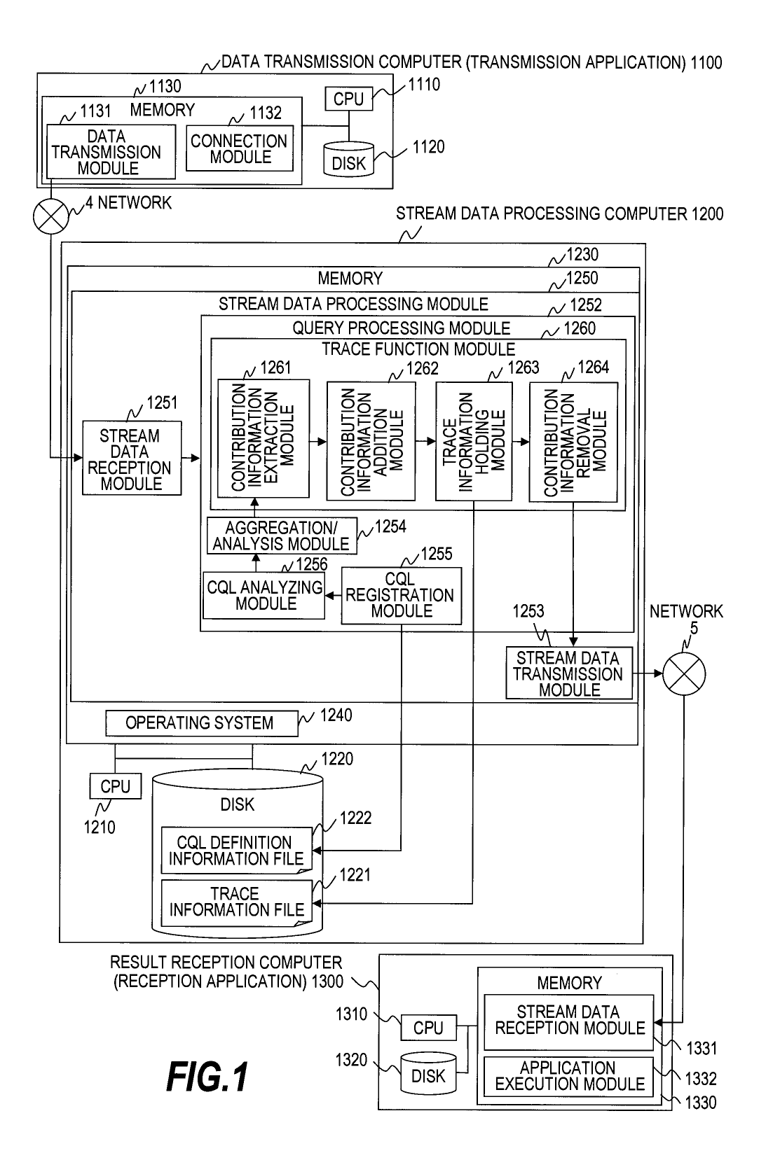

FIG. 1 is a block diagram illustrating an example of a configuration of the stream data processing system having the trace function according to a first embodiment of this invention.

The stream data processing system according to the first embodiment of this invention includes a data transmission computer 1100, a stream data processing computer 1200, and a result reception computer 1300.

The data transmission computer 1100 and the stream data processing computer 1200 are interconnected via a network 4, and the stream data processing computer 1200 and the result reception computer 1300 are interconnected via a network 5.

The data transmission computer 1100 generates stream data and transmits the generated stream data to the stream data processing computer 1200. The generation processing and the transmission processing for the stream data may be implemented by a program included in the data transmission computer 1100 or by dedicated hardware. This embodiment is described by taking an example where a transmission application is executed on the data transmission computer 1100.

The data transmission computer 1100 includes a CPU 1110, a DISK 1120, and a memory 1130.

The CPU 1110 executes a program loaded on the memory 1130.

The DISK 1120 stores data used by the program loaded on the memory 1130.

The memory 1130 stores the program executed by the CPU 1110 and data necessary to execute the program.

The memory 1130 includes a data transmission module 1131 and a connection module 1132. The connection module 1132 connects the data transmission computer 1100 to the stream data processing computer 1200 via the network 4. The data transmission module 1131 transmits the generated stream data to the stream data processing computer 1200 via the network 4. The generated stream data is, for example, read from the DISK 1120 or generated in a program. Specifically, as a conceivable manner, data stored on the DISK 1120 is read in time series, to thereby generate stream data.

The stream data processing computer 1200 receives stream data such as traffic information or stock price information, analyzes the received stream data, and transmits an analysis result to the result reception computer 1300.

The stream data processing computer 1200 includes a CPU 1210, a DISK 1220, and a memory 1230. The stream data processing computer 1200 may be a computer system such as a blade type computer system or a PC server.

The CPU 1210 executes a program loaded on the memory 1230.

The DISK 1220 stores data used by the program on the memory 1230.

Specifically, the DISK 1220 stores a trace information file 1221 and a CQL definition information file 1222.

The trace information file 1221 is a file in which an intermediate result and input information that contributed to the intermediate result, or a result and input information that contributed to the result are stored. The CQL definition information file 1222 is a file in which CQL definition information that is defined in advance is stored.

The memory 1230 stores the program executed by the CPU 1210 and data necessary to execute the program. Specifically, the memory 1230 includes an operating system 1240 and a stream data processing module 1250 that is a program operated on the operating system 1240.

The stream data processing module 1250 processes stream data received from the data transmission computer 1100. The stream data processing module 1250 includes a stream data reception module 1251, a query processing module 1252, and a stream data transmission module 1253.

The stream data reception module 1251 receives stream data from the data transmission module 1131 of the data transmission computer 1100 via the network 4.

The stream data transmission module 1253 transmits, via the network 5 to the result reception computer 1300, a result of an analysis executed by the query processing module 1252.

The query processing module 1252 analyzes the received stream data. The query processing module 1252 includes an aggregation/analysis module 1254, a CQL registration module 1255, a CQL analyzing module 1256, and a trace function module 1260.

The aggregation/analysis module 1254 aggregates and analyzes the stream data received by the stream data reception module 1251 according to a designated scenario that is input from the CQL analyzing module 1256. Further, the aggregation/analysis module 1254 outputs, to a contribution information extraction module 1261 of the trace function module 1260, input information that is input to an arbitrary query, and output information that is output from the arbitrary query.

The CQL registration module 1255 reads CQL definition information from the CQL definition information file 1222, and outputs the read CQL definition information to the CQL analyzing module 1256.

The CQL analyzing module 1256 analyzes the CQL definition information that is input from the CQL registration module 1255, and outputs, to the aggregation/analysis module 1254, information that defines stream data and processing of queries.

The trace function module 1260 identifies input information that contributed to a result. The trace function module 1260 includes the contribution information extraction module 1261, a contribution information addition module 1262, a trace information holding module 1263, and a contribution information removal module 1264.

The contribution information extraction module 1261 extracts input information that contributed to each of output results of queries when stream data is processed by the query processing module 1252. Specifically, the contribution information extraction module 1261 extracts input information that contributed to each of the output results of the queries based on information input from the aggregation/analysis module 1254. It should be noted that the output results of the queries include an intermediate result and a result.

The contribution information addition module 1262 adds, to each of the output results of the queries, the input information that contributed to each of the output results of the queries and is extracted by the contribution information extraction module 1261. Output information to which the input information that contributed to each of the output results of the queries is added is output to the trace information holding module 1263.

The trace information holding module 1263 stores information output from the query processing module 1252 in the trace information file 1221.

The contribution information removal module 1264 removes the input information added to the result. The contribution information removal module 1264 outputs the result from which the input information is removed to the stream data transmission module 1253.

The result reception computer 1300 receives stream data that is the result of the analysis executed by the stream data processing computer 1200, and executes various kinds of predetermined processing by using the received stream data. The reception processing for the stream data and the predetermined processing may be implemented by a program included in the result reception computer 1300 or by dedicated hardware.

The result reception computer 1300 includes a CPU 1310, a DISK 1320, and a memory 1330. In this embodiment, an example where a reception application is executed on the result reception computer 1300 is described.

The CPU 1310 executes a program loaded on the memory 1330.

The DISK 1320 stores data used by the program loaded on the memory 1330.

The memory 1330 stores the program executed by the CPU 1310 and data necessary to execute the program. The memory 1330 includes a stream data reception module 1331 and an application execution module 1332.

The stream data reception module 1331 receives stream data from the stream data processing computer 1200 via the network 5. The application execution module 1332 executes various kinds of predetermined processing by using the received stream data.

The predetermined processing is, for example, storage of data in an external storage device (not shown) or displaying of data on a display device (not shown).

It should be noted that the network 4 and the network 5 may be local area networks (LANs) connected by the Ethernet (registered trademark) or an optical fiber, or wide area networks (WANs) slower than LAN and including the Internet.

An example of the stream data may conceivably be stock price distribution information for a financial application, POS data for retailing, probe car information for a traffic information system, or an error log for computer system management.

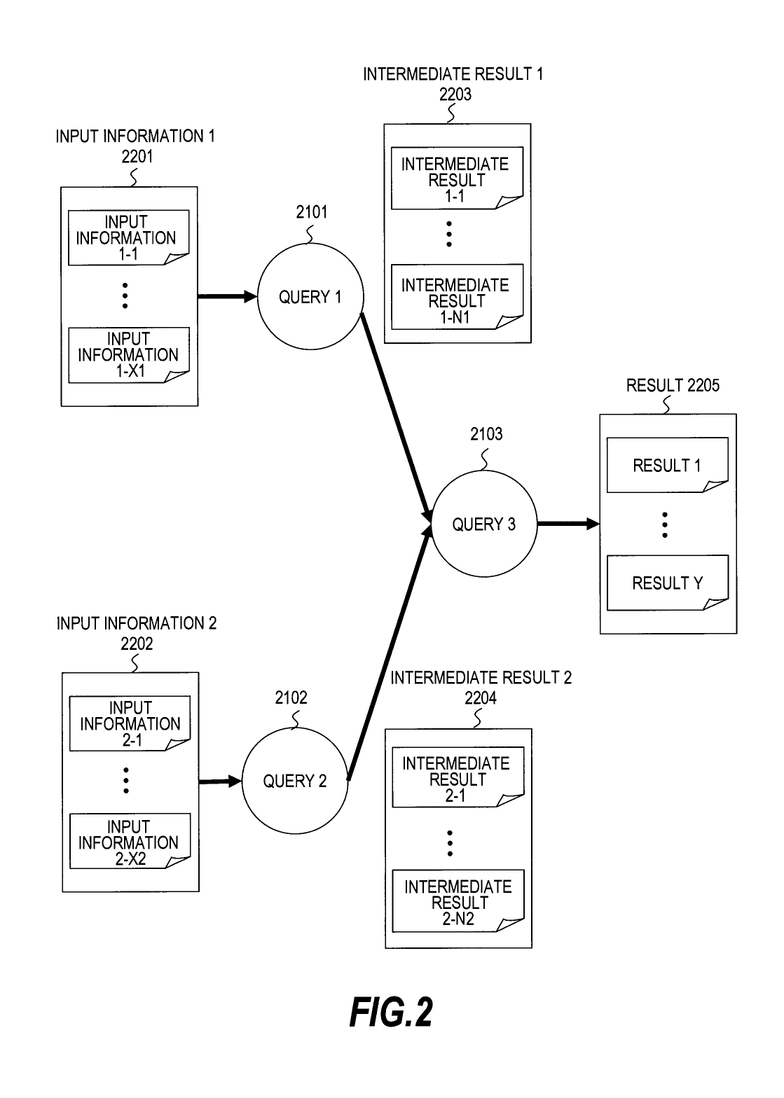

FIG. 2 is an explanatory diagram illustrating an example of a join query model according to the first embodiment of this invention.

The join query model illustrated in FIG. 2 is constituted by inputs of input information 1 (2201) and input information 2 (2202), a plurality of queries of a query 1 (2101), a query 2 (2102), and a query 3 (2103), an intermediate result 1 (2203) and an intermediate result 2 (2204), and a result 2205.

The input information 1 (2201) contains an arbitrary number (X1: X1 is an integer) of pieces of stream data. Specifically, the input information 1 (2201) contains input information 1-1 to input information 1-X1. The input information 2 (2202) contains an arbitrary number (X2: X2 is an integer) of pieces of stream data. Specifically, the input information 2 (2202) contains input information 2-1 to input information 2-X2.

The intermediate result 1 (2203) is an output result of the query 1 (2101), and contains an arbitrary number (N1: N1 is an integer) of pieces of stream data. Specifically, the intermediate result 1 (2203) contains an intermediate result 1-1 to an intermediate result 1-N1. The intermediate result 2 (2204) is an output result of the query 2 (2102), and contains an arbitrary number (N2: N2 is an integer) of pieces of stream data. Specifically, the intermediate result 2 (2204) contains an intermediate result 2-1 to an intermediate result 2-N2.

The result 2205 is an output result of the query 3 (2103), and contains an arbitrary number (Y: Y is an integer) of pieces of stream data. Specifically, the result 2205 contains a result 1 to a result Y.

Hereinbelow, description is given by taking the join query model illustrated in FIG. 2 as an example. It should be noted that the join query model does not lose its generality for processing procedures of the trace function of this invention, even in a case other than the example illustrated in FIG. 2, that is, a case where the structure of queries is changed.

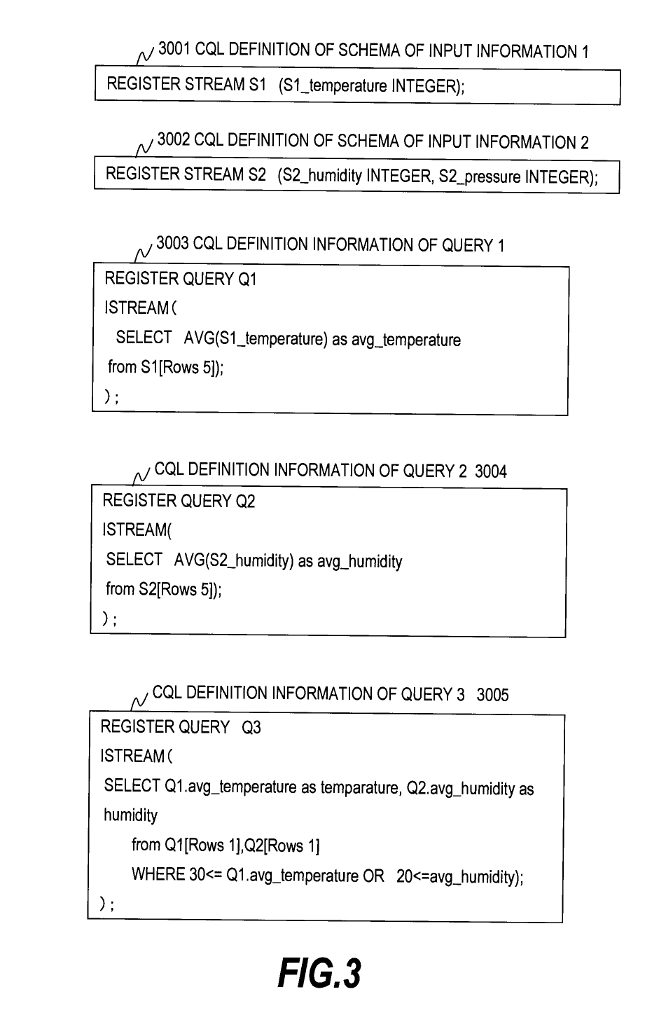

FIG. 3 is an explanatory diagram illustrating specific examples of input information and an analysis scenario according to the first embodiment of this invention.

This embodiment describes an example in which, in a certain research center, sensors are used to obtain information on temperature, humidity, and pressure, an alarm is issued when temperature or humidity has exceeded a given threshold value, and the cause of the alarm issuance is determined.

FIG. 3 illustrates examples of CQL definition information that defines schemas of the input information 1 (2201) and the input information 2 (2202) and processing contents of the query 1, the query 2, and the query 3 of FIG. 2.

CQL definition information 3001 of the schema of the input information 1 (2201) defines the schema of the input information 1 (2201) of FIG. 2. Specifically, the CQL definition information 3001 defines that the input information 1 (2201) contains the arbitrary number (X1: X1 is an integer) of pieces of stream data that have “temperature” as information.

CQL definition information 3002 of the schema of the input information 2 (2202) defines the schema of the input information 2 (2202) of FIG. 2. Specifically, the CQL definition information 3002 defines that the input information 2 (2202) contains the arbitrary number (X2: X2 is an integer) of pieces of stream data that have “humidity and pressure” as information.

CQL definition information 3003 of the query 1 indicates that the query 1 is a scenario of “calculating an average temperature with respect to five most recent pieces of input information (temperature) of the input information 1 (2201)”.

CQL definition information 3004 of the query 2 indicates that the query 2 is a scenario of “calculating an average humidity with respect to five most recent pieces of input information (humidity) of the input information 2 (2202)”.

CQL definition information 3005 of the query 3 indicates that the query 3 is a scenario of “outputting an average temperature and an average humidity at a current time in a case where a result showing that the average temperature is 30° C. or higher or the average humidity is 20% or higher is output with respect to one most recent piece of input information (average temperature) and one most recent piece of input information (average humidity)”.

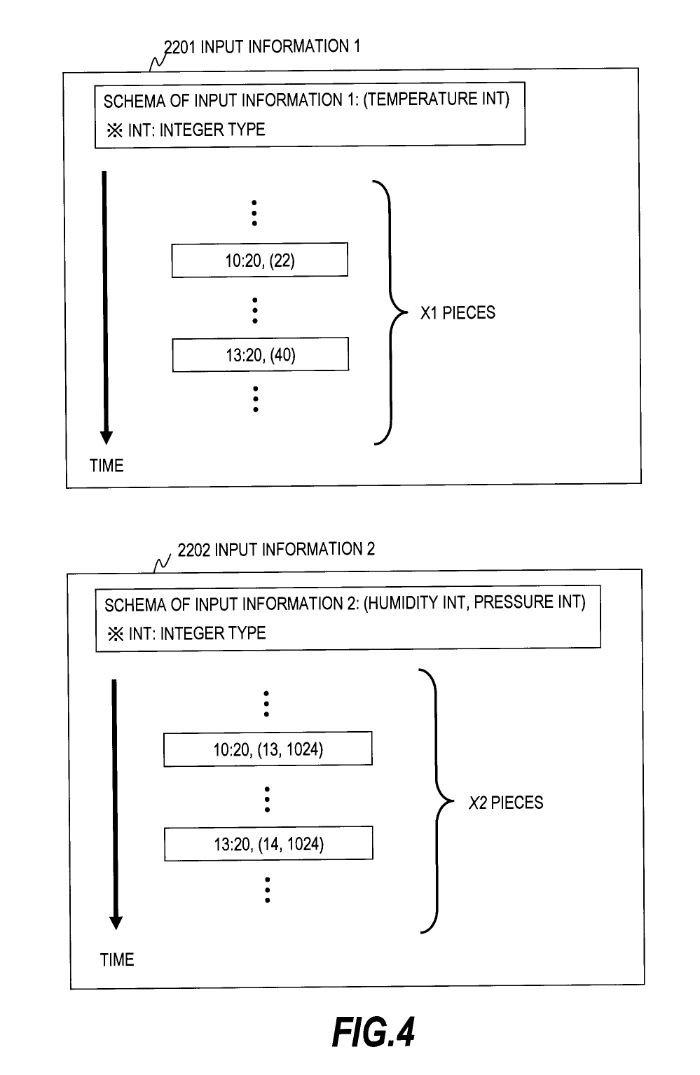

FIG. 4 is an explanatory diagram illustrating examples of the input information 1 (2201) and the input information 2 (2202) according to the first embodiment of this invention.

In the example illustrated in FIG. 4, the input information 1 (2201) contains X1 pieces of data arranged in time series. Specifically, each data of the input information 1 (2201) contains time and temperature. In the example illustrated in FIG. 4, the input information 1 (2201) contains data that contains a time of “10:20” and a temperature of “22”.

Further, the input information 2 (2202) contains X2 pieces of data arranged in time series. Specifically, each data of the input information 2 (2202) contains time, humidity, and pressure. In the example illustrated in FIG. 4, the input information 2 (2202) contains data that contains a time of “10:20”, a humidity of “13”, and a pressure of “1024”.

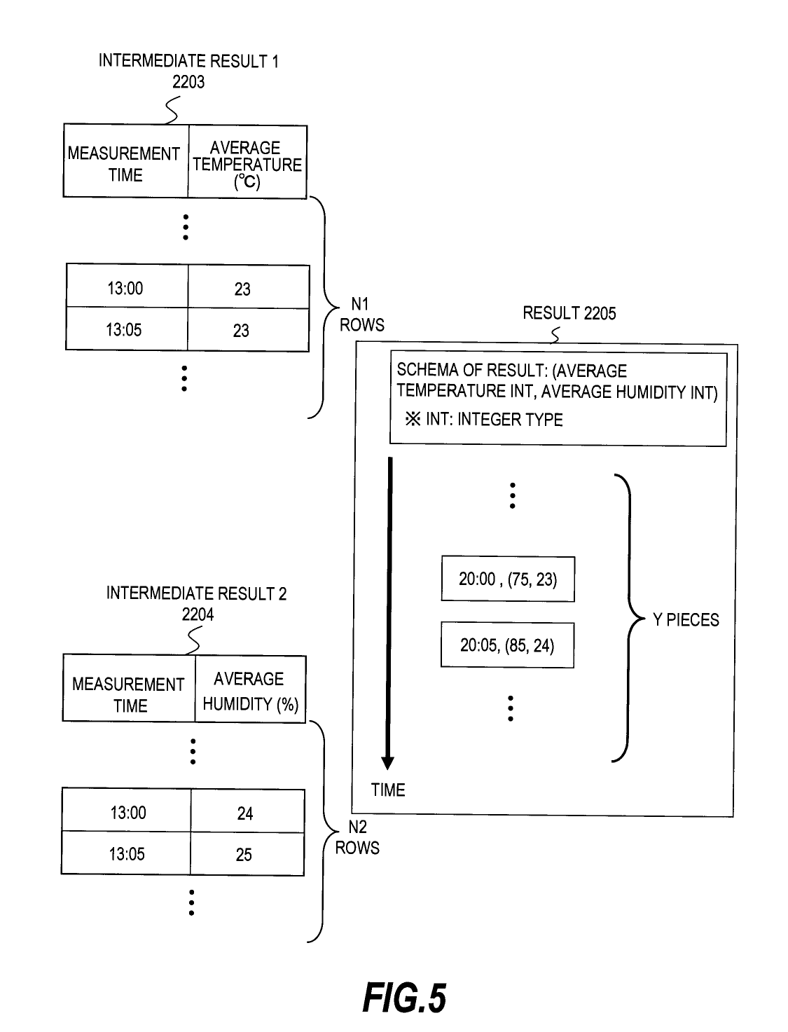

FIG. 5 is an explanatory diagram illustrating examples of the intermediate result 1 (2203) and the intermediate result 2 (2204) according to the first embodiment of this invention.

As illustrated in FIG. 5, the intermediate result 1 (2203) serving as the output result of the query 1 is a table [measurement time, average temperature] containing N1 (N1 is an integer) entries.

Further, the intermediate result 2 (2204) serving as the output result of the query 2 is a table [measurement time, humidity, pressure] containing N2 (N2 is an integer) entries.

Further, the result 2205 is Y (Y is an integer) pieces of stream data containing a schema (average temperature and average humidity).

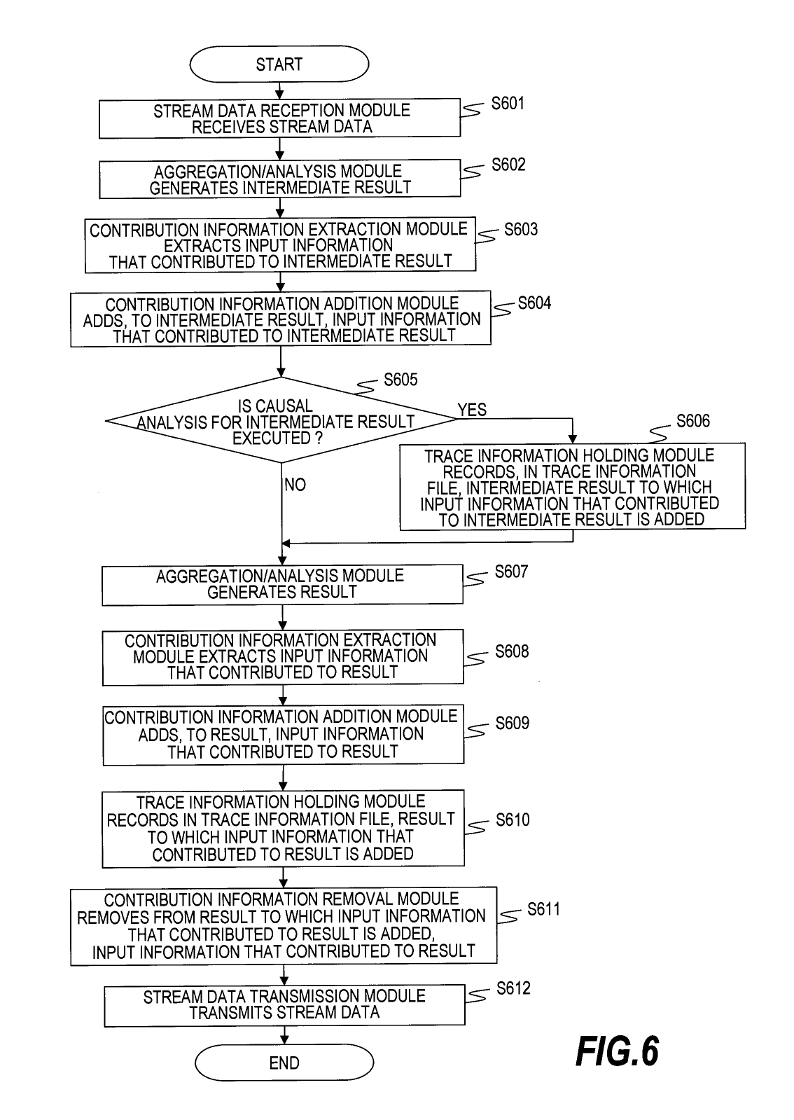

FIG. 6 is a flow chart illustrating processing of the trace function that is provided to the stream data processing computer 1200 according to the first embodiment of this invention.

The stream data reception module 1251 receives stream data from the data transmission computer 1100 (Step S601).

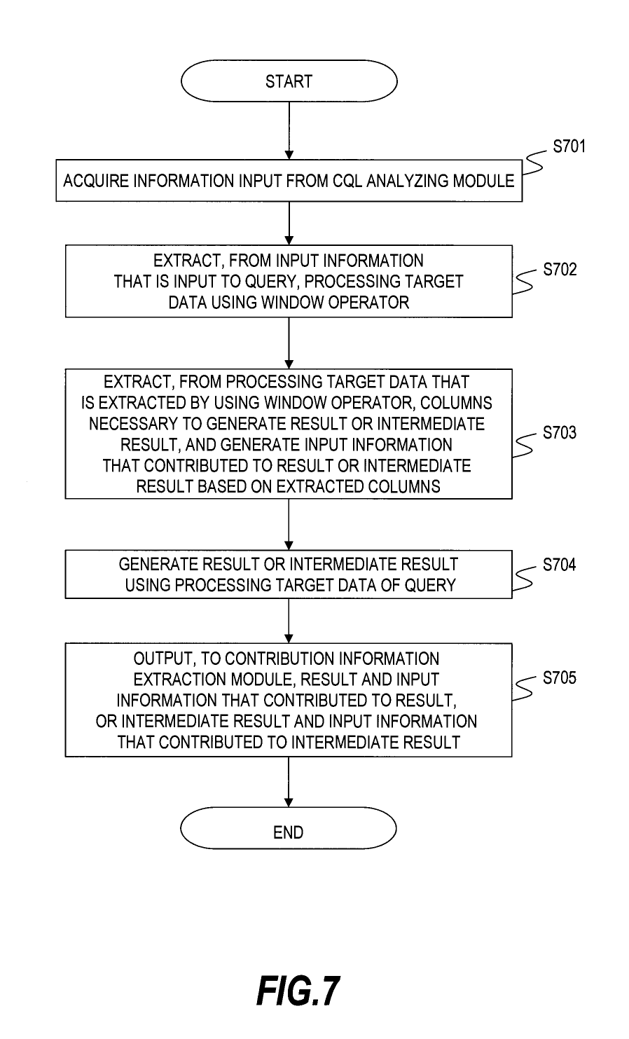

The aggregation/analysis module 1254 executes a query using the received stream data to generate an intermediate result (Step S602). In the example illustrated in FIG. 2, the aggregation/analysis module 1254 executes the query 1 (2101) to generate the intermediate result 1 (2203), and executes the query 2 (2102) to generate the intermediate result 2 (2204). It should be noted that details of the processing executed by the aggregation/analysis module 1254 are described later referring to FIG. 7.

The aggregation/analysis module 1254 outputs, to the contribution information extraction module 1261, the generated intermediate result and input information that contributed to the intermediate result.

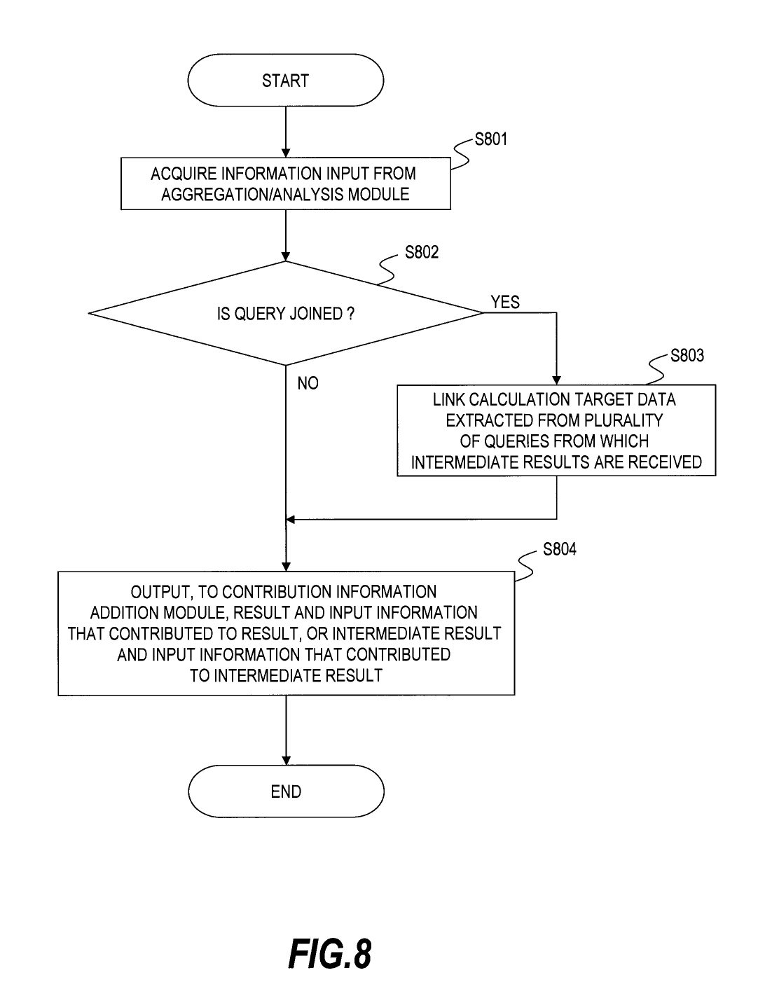

The contribution information extraction module 1261 extracts the input information that contributed to the intermediate result based on the information input from the aggregation/analysis module 1254 (Step S603). It should be noted that details of the processing executed by the contribution information extraction module 1261 are described later referring to FIG. 8.

The contribution information extraction module 1261 outputs, to the contribution information addition module 1262, the intermediate result and the extracted input information that contributed to the intermediate result.

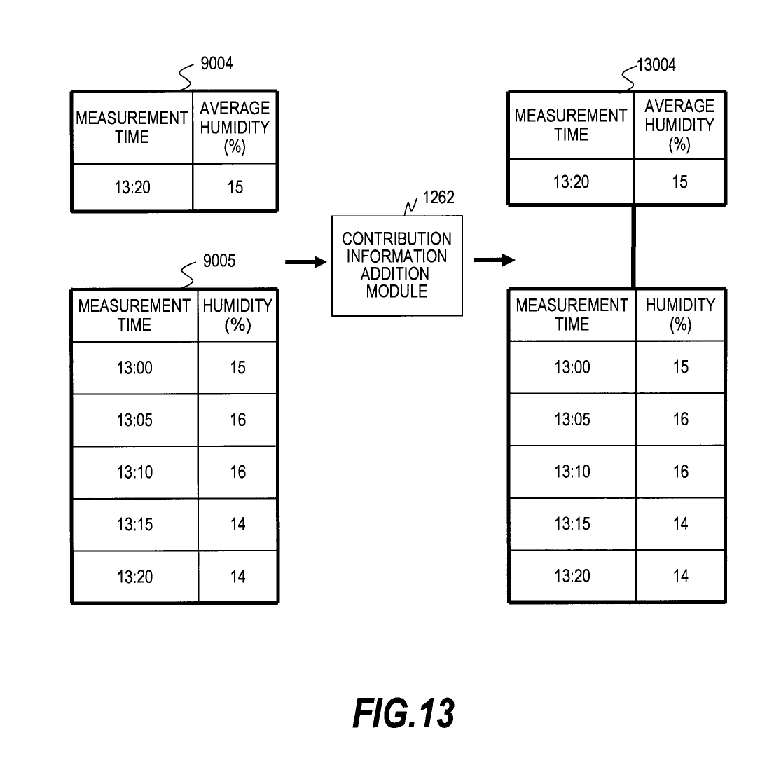

The contribution information addition module 1262 adds, to the intermediate result, the input information that contributed to the intermediate result based on the information input from the contribution information extraction module 1261 (Step S604). In other words, the intermediate result and the input information that contributed to the intermediate result are linked to each other. It should be noted that an example of the processing of Step S604 is described later referring to FIG. 13.

The contribution information addition module 1262 outputs, to the trace information holding module 1263, the intermediate result to which the input information that contributed to the intermediate result is added. It should be noted that the intermediate result to which the input information that contributed to the intermediate result is added may be output to the trace information holding module 1263 every time an intermediate result is output from the query, at fixed time intervals, every time a fixed data amount is reached, or at a timing at which the final result is output.

Subsequently, the trace information holding module 1263 judges whether or not to execute a causal analysis for the intermediate result with respect to the intermediate result which is input from the contribution information addition module 1262 and to which the input information that contributed to the intermediate result is added (Step S605). The judgment is executed by, for example, judging whether or not any parameter indicating that a causal analysis for the intermediate result is executed is set in advance to the DISK 1120 or the like.

When it is judged that the causal analysis for the intermediate result is executed, the trace information holding module 1263 stores, in the trace information file 1221, the intermediate result to which the input information that contributed to the intermediate result is added (Step S606), and the processing proceeds to Step S607.

When it is judged that the causal analysis for the intermediate result is not executed, the aggregation/analysis module 1254 executes a query using the input information or the intermediate result to generate a result (Step S607). In the example illustrated in FIG. 2, the aggregation/analysis module 1254 executes the query 3 (2103) to generate the result 2205.

The aggregation/analysis module 1254 outputs, to the contribution information extraction module 1261, the generated result and input information that contributed to the result.

The contribution information extraction module 1261 extracts the input information that contributed to the result based on the information input from the aggregation/analysis module 1254 (Step S608).

The contribution information extraction module 1261 outputs, to the contribution information addition module 1262, the result and the input information that contributed to the result.

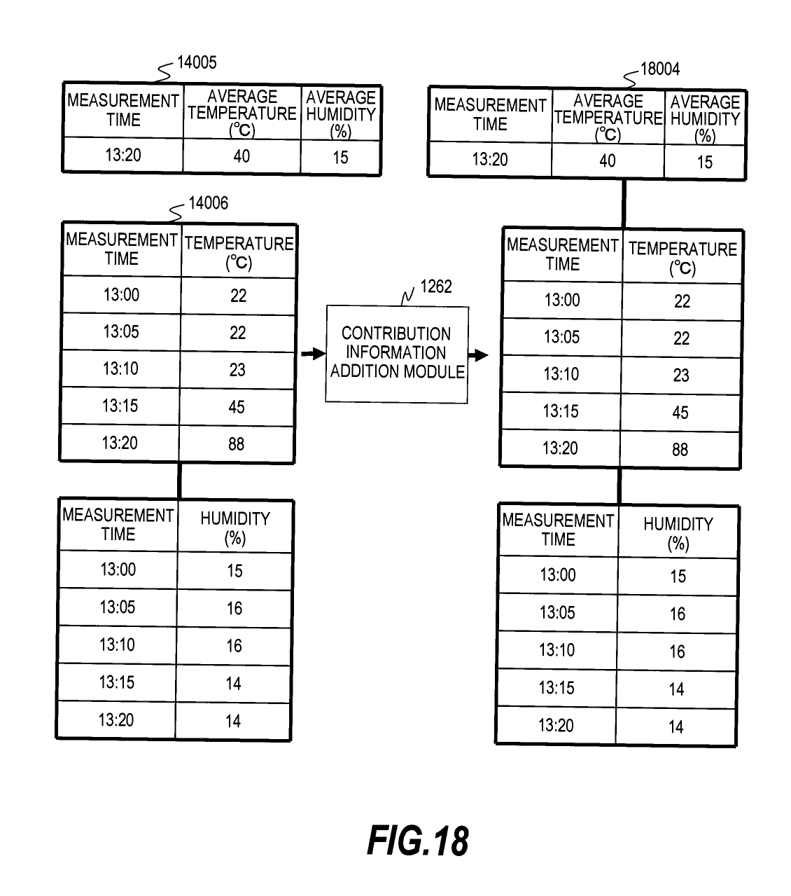

The contribution information addition module 1262 adds, to the result, the input information that contributed to the result based on the information input from the contribution information extraction module 1261 (Step S609). In other words, the result and the input information that contributed to the result are linked to each other. It should be noted that an example of the processing of Step S609 is described later referring to FIG. 18.

The contribution information addition module 1262 outputs, to the trace information holding module 1263, the result to which the input information that contributed to the result is added. It should be noted that the result to which the input information that contributed to the result is added may be output to the trace information holding module 1263 every time a result is output, at fixed time intervals, or every time a fixed data amount is reached.

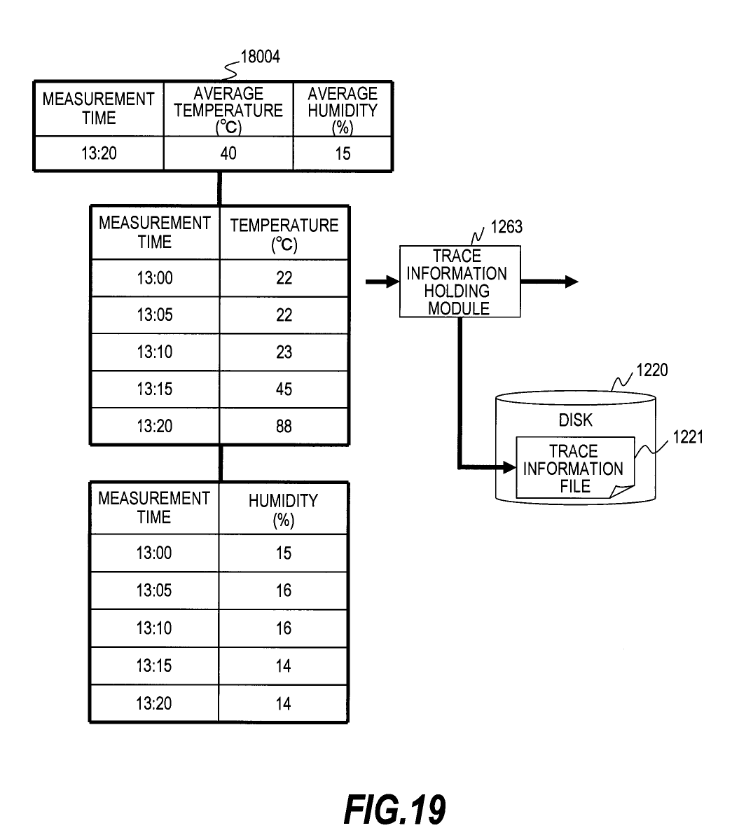

The trace information holding module 1263 stores, in the trace information file 1221, the result to which the input information that contributed to the result is added (Step S610). It should be noted that an example of the processing of Step S610 is described later referring to FIG. 19.

The trace information holding module 1263 outputs, to the contribution information removal module 1264, the result to which the input information that contributed to the result is added.

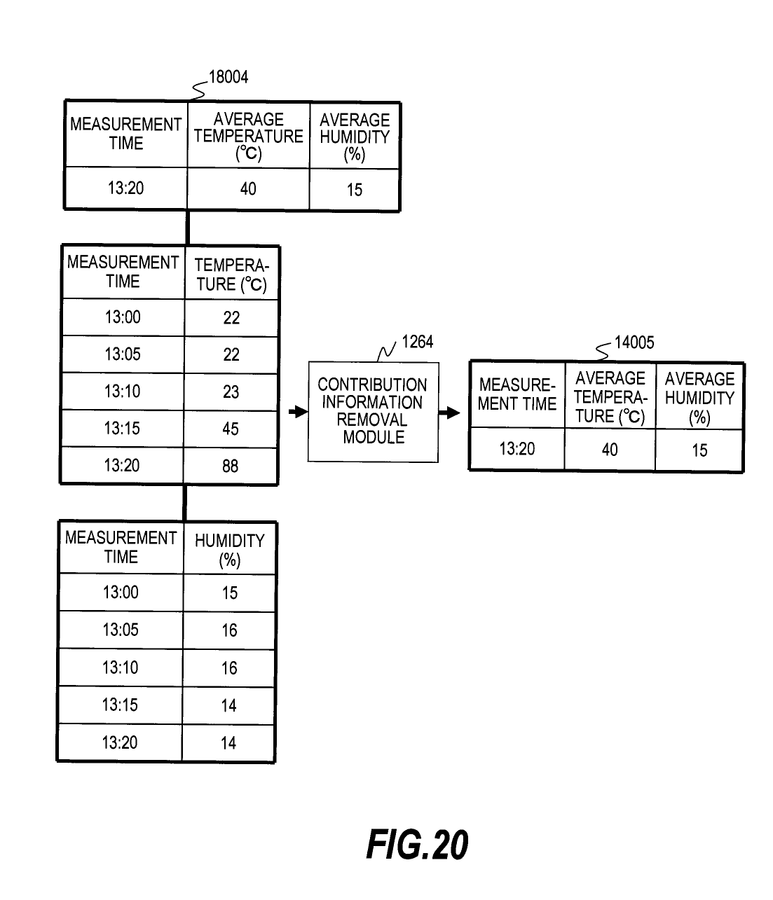

The contribution information removal module 1264 removes, from the result to which the input information that contributed to the result is added, the input information that contributed to the result (Step S611). It should be noted that an example of the processing of Step S611 is described later referring to FIG. 20.

The contribution information removal module 1264 outputs, to the stream data transmission module 1253, the result from which the input information that contributed to the result is removed.

The stream data transmission module 1253 transmits, via the network 5 to the result reception computer 1300, the result from which the input information that contributed to the result is removed (Step S612).

It should be noted that, in a case where the intermediate result needs to be output, the intermediate result to which the input information that contributed to the intermediate result is added is input to the contribution information removal module 1264, and the contribution information removal module 1264 removes therefrom the input information that contributed to the intermediate result. Further, the stream data transmission module 1253 transmits, to the result reception computer 1300, the intermediate result from which the input information that contributed to the intermediate result is removed. Accordingly, the intermediate result can be output.

FIG. 7 is a flow chart illustrating processing executed by the aggregation/analysis module 1254 according to the first embodiment of this invention.

The aggregation/analysis module 1254 acquires information input from the CQL analyzing module 1256 (Step S701). For example, the aggregation/analysis module 1254 acquires information on processing of queries.

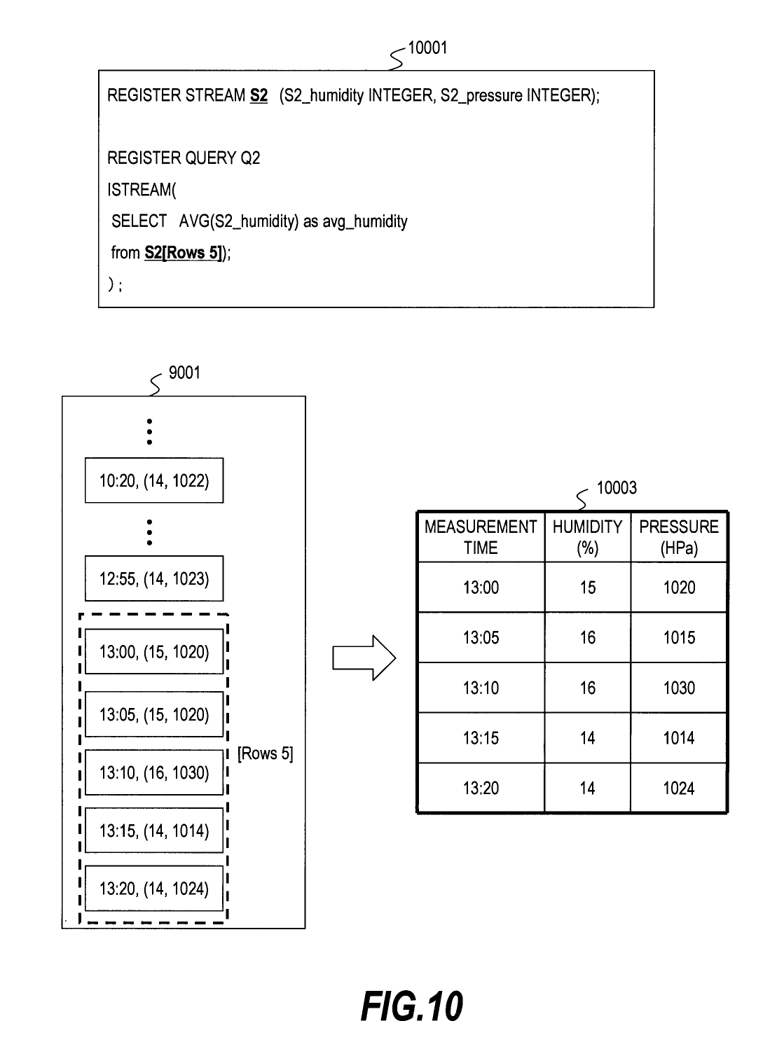

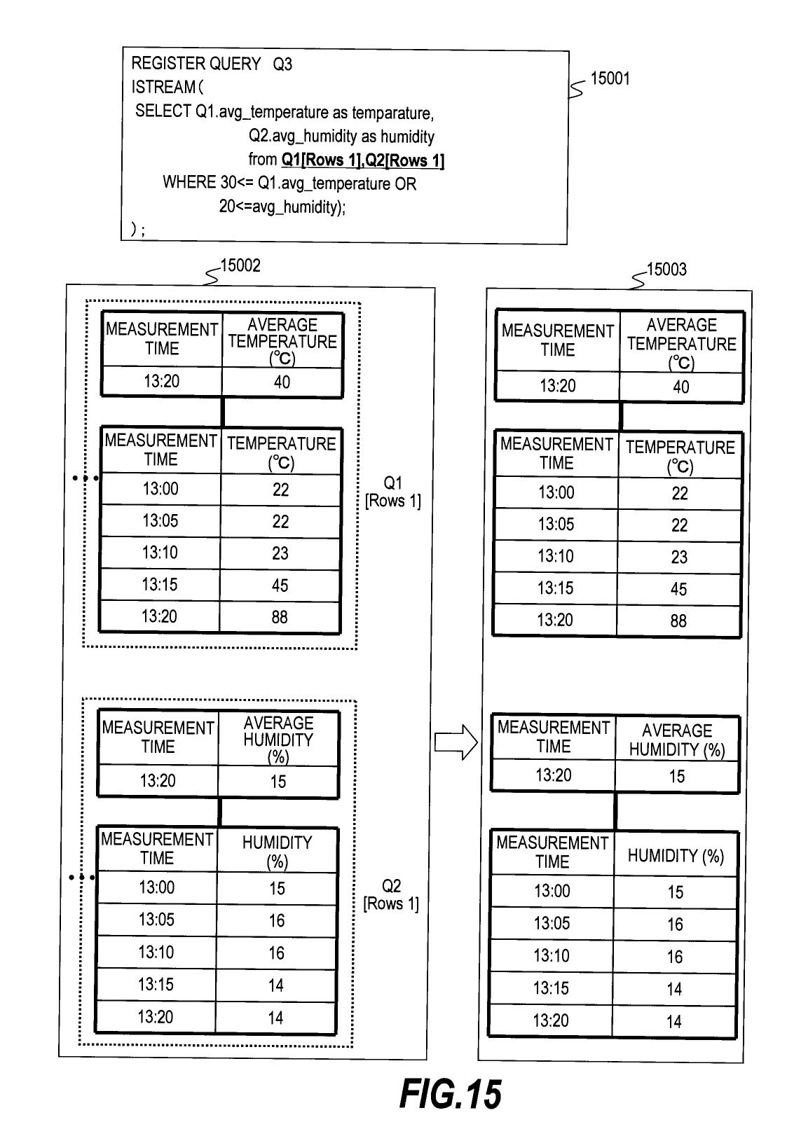

The aggregation/analysis module 1254 extracts, from input information that is input to a query, processing target data based on a predetermined window operator (Step S702). In this case, the window operator is used for, for example, designating, from input information, data falling within a range of three minutes as a processing target. Specifically, because data is input incessantly in the stream data processing system, the processing target needs to be specified, and thus the window operator is used for specifying the processing target. It should be noted that an example of the processing of Step 5702 is described later referring to FIGS. 10 and 15.

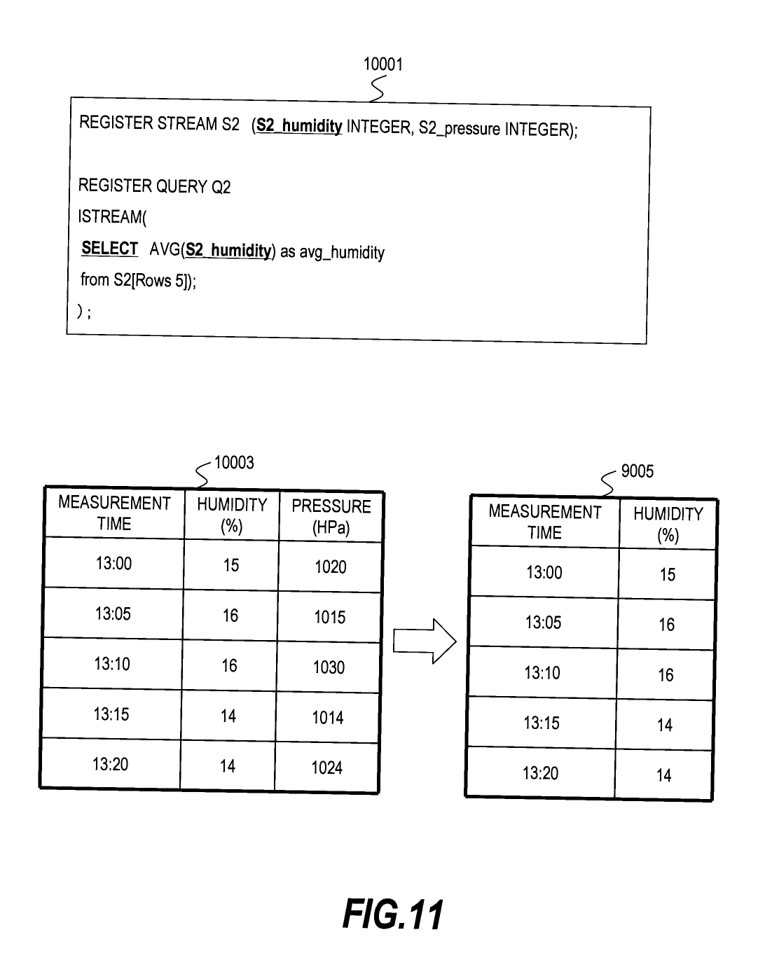

The aggregation/analysis module 1254 extracts, from the processing target data that is extracted by using the window operator, columns necessary to generate a result or an intermediate result, and generates input information that contributed to a result or an intermediate result based on the extracted columns (Step S703). It should be noted that an example of the processing of Step S703 is described later referring to FIG. 11.

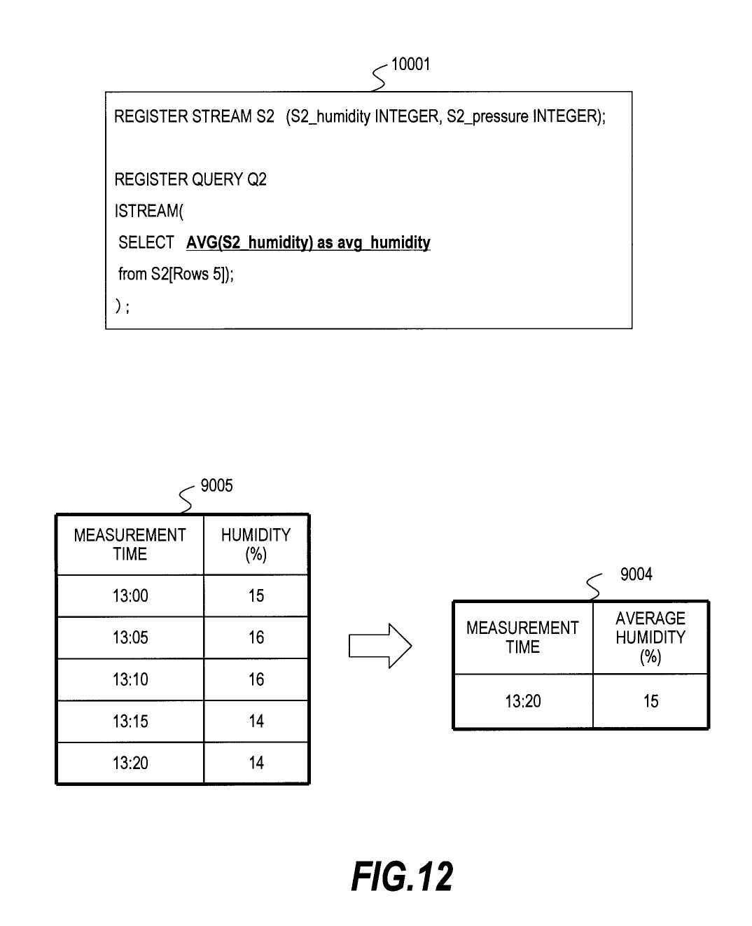

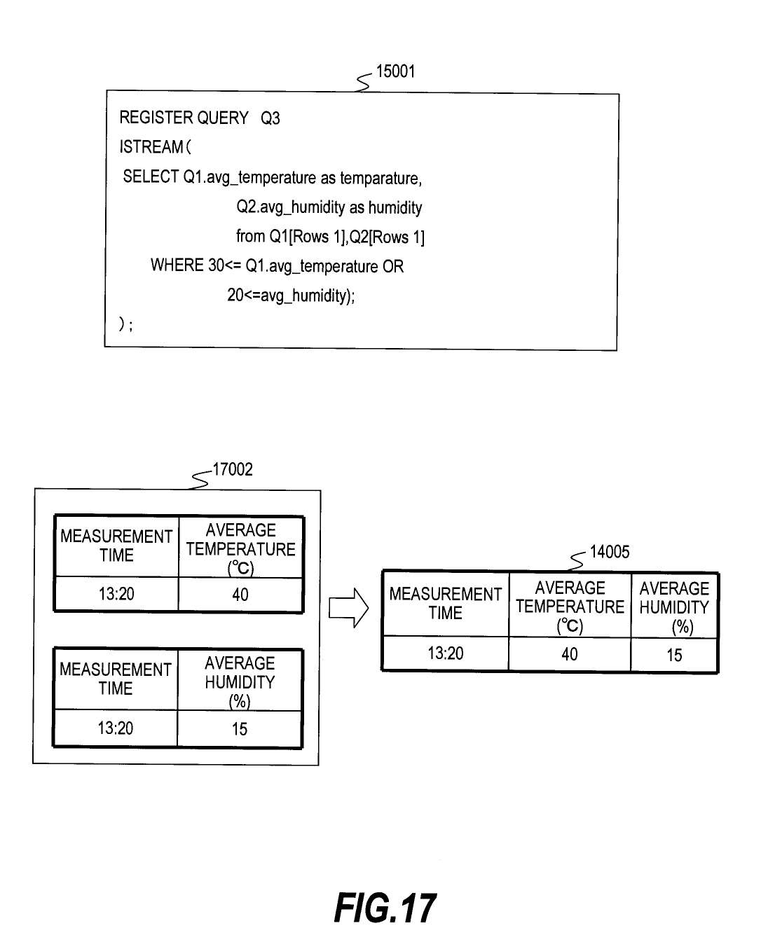

The aggregation/analysis module 1254 generates a result or an intermediate result using the processing target data of the query (Step S704). It should be noted that an example of the processing of Step S704 is described later referring to FIGS. 12 and 17.

The aggregation/analysis module 1254 outputs, to the contribution information extraction module 1261, the result and the input information that contributed to the result, or the intermediate result and the input information that contributed to the intermediate result (Step S705).

FIG. 8 is a flow chart illustrating processing executed by the contribution information extraction module 1261 according to the first embodiment of this invention.

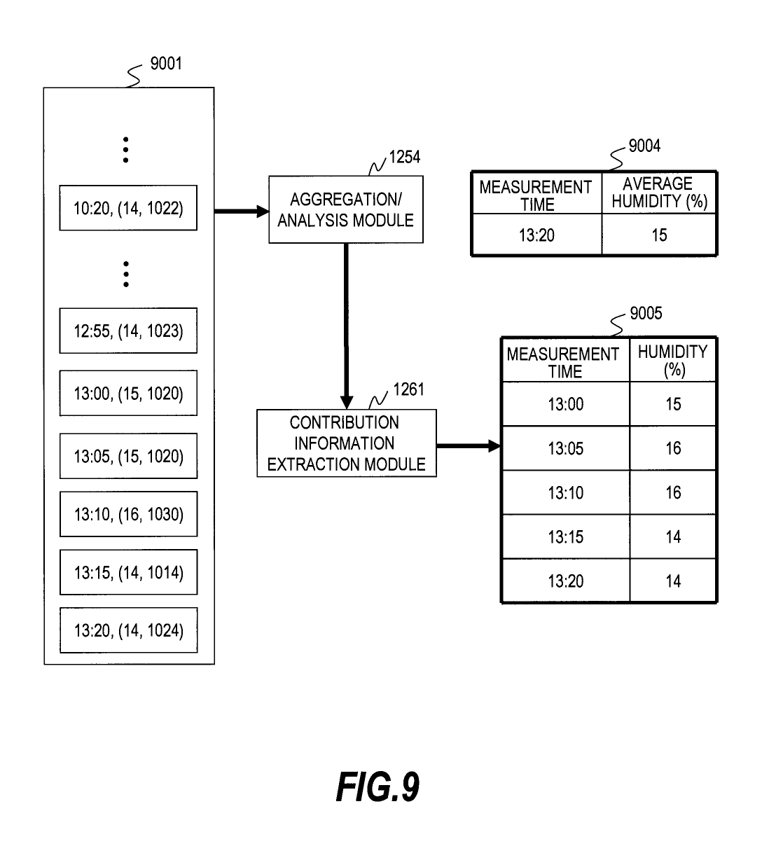

The contribution information extraction module 1261 acquires information input from the aggregation/analysis module 1254 (Step S801). Specifically, a result and input information that contributed to the result, or an intermediate result and input information that contributed to the intermediate result are input to the contribution information extraction module 1261. It should be noted that an example of the processing of Step S801 is described later referring to FIG. 9.

The contribution information extraction module 1261 judges whether or not other queries are joined to the query from which the acquired result or intermediate result is output (hereinafter, referred to as judgment target query) (Step S802). The contribution information extraction module 1261 judges whether or not other queries are joined to the judgment target query by, for example, referencing CQL definition information of the judgment target query.

In the example illustrated in FIG. 2, in a case where the query 3 (2103) is the judgment target query, it is judged that other queries (query 1 (2101) and query 2 (2102)) are joined to the query 3 (2103).

When it is judged that other queries are joined to the judgment target query, the contribution information extraction module 1261 links processing target data of those other queries to the result or intermediate result output from the judgment target query (Step S803), and the processing proceeds to Step S804. The processing target data of the above-mentioned other queries serves as input information that contributed to the result or intermediate result output from the judgment target query.

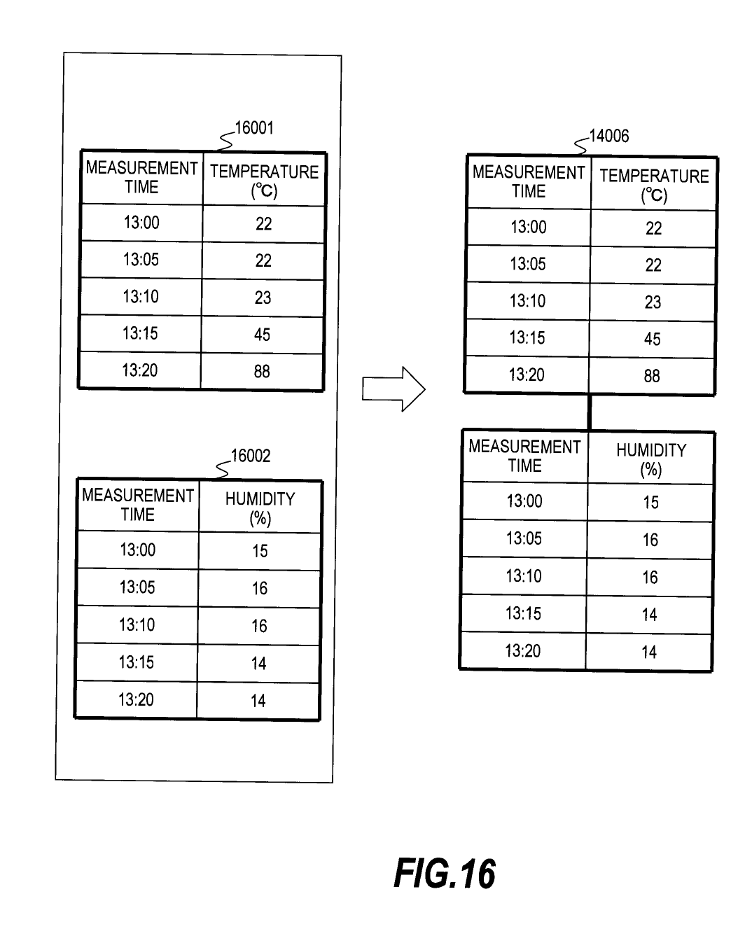

For example, in a case where the query 3 (2103) is the judgment target query, processing target data of the query 1 (2101) and processing target data of the query 2 (2102) are linked to the result 2205. It should be noted that an example of the processing of Step S803 is described later referring to FIG. 16.

When it is judged that other queries are not joined to the judgment target query, the contribution information extraction module 1261 outputs, to the contribution information addition module 1262, the result and the input information that contributed to the result, or the intermediate result and the input information that contributed to the intermediate result (Step S804).

Hereinbelow, description is given of an example of a series of processing executed in the stream data processing computer 1200 having the trace function. It should be noted that the description is given by taking the join query model illustrated in FIG. 2 as an example.

FIG. 9 is an explanatory diagram illustrating an example of input and output of the contribution information extraction module 1261 in the query 2 (2102) according to the first embodiment of this invention.

In the example illustrated in FIG. 9, input information 9001 of the query 2 (2102) is input to the aggregation/analysis module 1254. The input information 9001 is the same as the input information 2 (2202).

The aggregation/analysis module 1254 uses the input information 9001 to generate an output 9004 of the query 2 (2102). In the example illustrated in FIG. 9, the output 9004 is an output at a measurement time of “13:20”. The output 9004 is the same as the intermediate result 2 (2204).

The aggregation/analysis module 1254 further generates input information 9005 that contributed to the output 9004. After that, the aggregation/analysis module 1254 outputs the output 9004 and the input information 9005 to the contribution information extraction module 1261. The input information 9005 is input information at the measurement time of “13:20”.

The contribution information extraction module 1261 extracts the input information 9005 from the information input from the aggregation/analysis module 1254, and outputs the output 9004 and the input information 9005 to the contribution information addition module 1262.

Hereinbelow, referring to FIGS. 10 to 12, description is given of a specific example of the processing of generating the output 9004 and the input information 9005, which is executed by the aggregation/analysis module 1254.

FIG. 10 is an explanatory diagram illustrating an example of processing of extracting processing target data based on a window operator in the query 2 (2102), which is executed by the aggregation/analysis module 1254 according to the first embodiment of this invention.

As illustrated in FIG. 10, the aggregation/analysis module 1254 extracts processing target data 10003 from the input information 9001 based on a window designated by CQL definition information 10001 of the query 2 (2102).

It should be noted that the aggregation/analysis module 1254 uses the extracted processing target data 10003 to calculate an average humidity at the measurement time of “13:20”. Specifically, the aggregation/analysis module 1254 calculates the average humidity based on five most recent pieces of input information (humidity) with respect to the measurement time of “13:20”.

The aggregation/analysis module 1254 uses the designated ROW window operator to extract five most recent pieces of input information starting from a measurement time of “13:00” (in this case, [13:00, (15, 1020)], [13:05, (16, 1015)], [13:10, (16, 1030)], [13:15, (14, 1014)], and [13:20, (14, 1024)]) from the input information 9001, and generates the processing target data 10003 based on the extracted input information. The processing target data 10003 is specifically generated as a table that has five rows and three columns and contains the measurement time, humidity, and pressure.

FIG. 11 is an explanatory diagram illustrating an example of processing of extracting columns necessary to generate the output 9004 from the processing target data 10003 in the query 2 (2102), which is executed by the aggregation/analysis module 1254 according to the first embodiment of this invention.

As illustrated in FIG. 11, the aggregation/analysis module 1254 extracts columns necessary to generate the output 9004 from the processing target data 10003 based on the CQL definition information 10001 of the query 2 (2102). Specifically, the aggregation/analysis module 1254 extracts the input information 9005 that contributed to the output 9004.

In the example illustrated in FIG. 11, the measurement time and humidity are designated as columns necessary to generate the output 9004. Therefore, the aggregation/analysis module 1254 extracts columns of the measurement time and humidity from the processing target data 10003, and generates the input information 9005. Specifically, the generated input information 9005 is a table that has five rows and two columns and contains the measurement time and humidity.

Through the processing described above, the aggregation/analysis module 1254 can extract, from input information that is input to a query, information that contributed to a result of the query.

FIG. 12 is an explanatory diagram illustrating an example of processing of generating the output 9004 of the query 2 (2102), which is executed by the aggregation/analysis module 1254 according to the first embodiment of this invention.

As illustrated in FIG. 12, the aggregation/analysis module 1254 uses the input information 9005, and executes calculation designated by the CQL definition information 10001 of the query 2 (2102) to generate the output 9004 of the query 2 (2102).

Specifically, the input information 9005 indicates [13:00, 15], [13:05, 16], [13:10, 16], [13:15, 14], and [13:20, 14], and in the scenario of the query 2 (2102), calculation for deriving an average of humidity is designated. Hence, the output 9004 indicates [13:20, 15].

Hereinabove, the description is given of the specific example of the processing of generating the output 9004 and the input information 9005, which is executed by the aggregation/analysis module 1254.

FIG. 13 is an explanatory diagram illustrating an example of processing executed by the contribution information addition module 1262 in the query 2 (2102) according to the first embodiment of this invention.

The contribution information addition module 1262 adds the input information 9005 to the output 9004, to thereby generate an intermediate result 13004 to which input information that contributed to the intermediate result 2 (2204) of the query 2 (2102) is added.

It should be noted that processing similar to the processing described referring to FIGS. 9 to 13 is executed for the query 1 (2101).

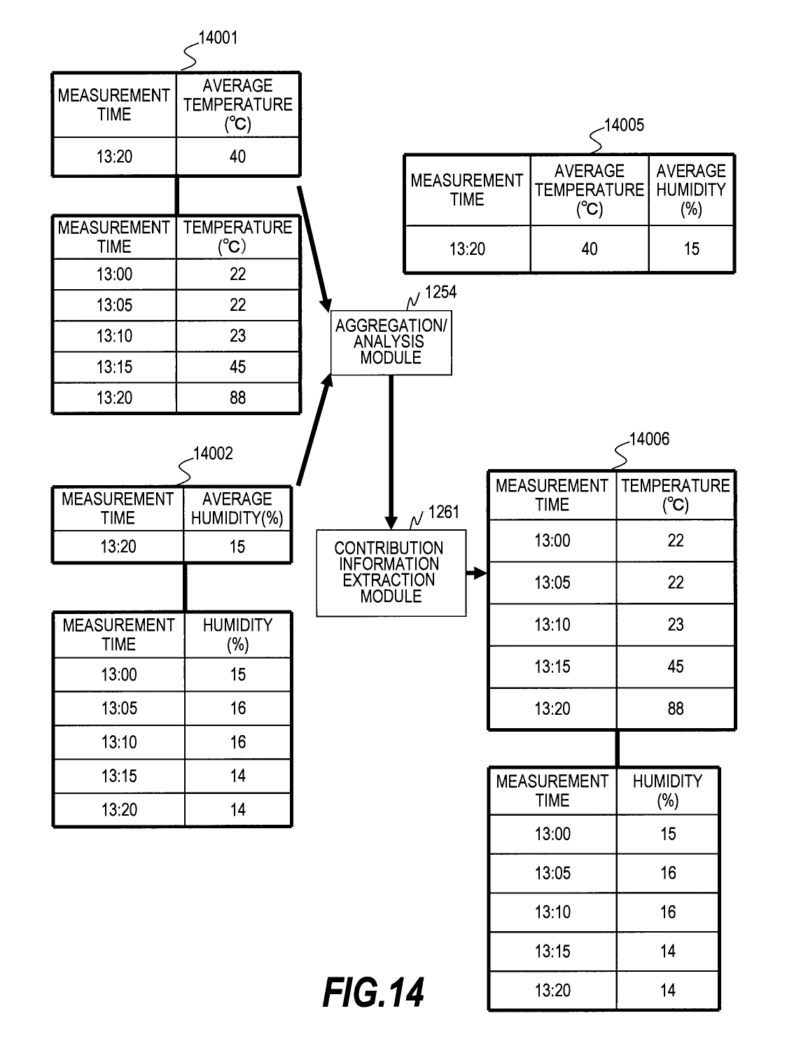

FIG. 14 is an explanatory diagram illustrating an example of input and output of the contribution information extraction module 1261 in the query 3 (2103) according to the first embodiment of this invention.

In the example illustrated in FIG. 14, information 14001 that is output from the query 1 (2101) and input to the query 3 (2103), and information 14002 that is output from the query 2 (2102) and input to the query 3 (2103) are input to the aggregation/analysis module 1254. The information 14002 is the same as the intermediate result 13004.

The aggregation/analysis module 1254 uses the information 14001 and the information 14002 to generate an output 14005 of the query 3 (2103). In the example illustrated in FIG. 14, the output 14005 is an output at the measurement time of “13:20”. The output 14005 is the same as the result 2205.

The aggregation/analysis module 1254 further generates input information of the query 1 (2101) and input information of the query 2 (2102) that contributed to the output 14005, and outputs, to the contribution information extraction module 1261, the output 14005, and the input information of the query 1 (2101) and the input information of the query 2 (2102) that contributed to the output 14005.

The contribution information extraction module 1261 generates input information 14006 that contributed to the output 14005 based on the input information of the query 1 (2101) and the input information of the query 2 (2102) that are input from the aggregation/analysis module 1254 and contributed to the output 14005. In the example illustrated in FIG. 14, the input information 14006 is an output at the measurement time of “13:20”.

The contribution information extraction module 1261 extracts the input information 14006 from the information input from the aggregation/analysis module 1254, and outputs the output 14005 and the input information 14006 to the contribution information addition module 1262.

FIG. 15 is an explanatory diagram illustrating an example of processing of extracting processing target data based on a window operator in the query 3 (2103), which is executed by the aggregation/analysis module 1254 according to the first embodiment of this invention.

As illustrated in FIG. 15, the aggregation/analysis module 1254 extracts processing target data 15003 from input information 15002 based on windows designated by CQL definition information 15001 of the query 3 (2103). It should be noted that the input information 15002 is stream data.

In addition, the processing target data 15003 contains the information 14001 and the information 14002.

It should be noted that the query 3 (2103) is a scenario of outputting an average temperature and an average humidity at a current time using the extracted processing target data 15003 in a case where a result showing that the average temperature is 30° C. or higher or the average humidity is 20% or higher is output.

The aggregation/analysis module 1254 extracts one most recent piece of input information with respect to the measurement time of “13:20” (in this case, information at the measurement time of “13:20”) from the input information 15002 based on each of the designated ROW window operators, and generates the processing target data 15003 based on the extracted input information.

FIG. 16 is an explanatory diagram illustrating an example of processing executed by the contribution information extraction module 1261 in the query 3 (2103) according to the first embodiment of this invention.

In FIG. 16, the contribution information extraction module 1261 extracts, from the information 14001 and the information 14002, an output of the query 1 (2101), that is, input information 16001 that contributed to the information 14001, and an output of the query 2 (2102), that is, input information 16002 that contributed to the information 14002. The contribution information extraction module 1261 then links the input information 16001 and the input information 16002 to each other to generate the input information 14006 that contributed to the result of the query 3 (2103).

FIG. 17 is an explanatory diagram illustrating an example of processing of generating the output 14005 of the query 3 (2103), which is executed by the aggregation/analysis module 1254 according to the first embodiment of this invention.

As illustrated in FIG. 17, the aggregation/analysis module 1254 uses processing target data 17002, and executes calculation designated by the CQL definition information 15001 of the query 3 (2103) to generate the output 14005 of the query 3 (2103).

Specifically, the query 3 (2103) is a scenario of outputting an average temperature and an average humidity at a current time in a case where a result showing that the average temperature is 30° C. or higher or the average humidity is 20% or higher is output. Further, the processing target data 17002 indicates the measurement time of “13:20” and an average temperature of 40° C., and the measurement time of “13:20” and an average humidity of 15%. Hence, the output 14005 of the query 3 (2103) indicates [13:20, 40, 15].

FIG. 18 is an explanatory diagram illustrating an example of processing executed by the contribution information addition module 1262 in the query 3 (2103) according to the first embodiment of this invention.

The contribution information addition module 1262 adds the input information 14006 to the output 14005, to thereby generate a result 18004 to which input information that contributed to the result 2205 of the query 3 (2103) is added.

FIG. 19 is an explanatory diagram illustrating an example of processing executed by the trace information holding module 1263 according to the first embodiment of this invention.

The trace information holding module 1263 stores, in the trace information file 1221, the result 18004 that is input from the contribution information addition module 1262.

FIG. 20 is an explanatory diagram illustrating an example of processing executed by the contribution information removal module 1264 according to the first embodiment of this invention.

The contribution information removal module 1264 removes, from the result 18004, input information that contributed to the result 18004 (input information 14006), and generates the result 2205 of the query 3 (2103) (output 14005).

According to the first embodiment of this invention, in the stream data processing, information regarding the input information that contributed to the output result can be held, and accordingly, the causal analysis for the result can be executed.

### Second Embodiment

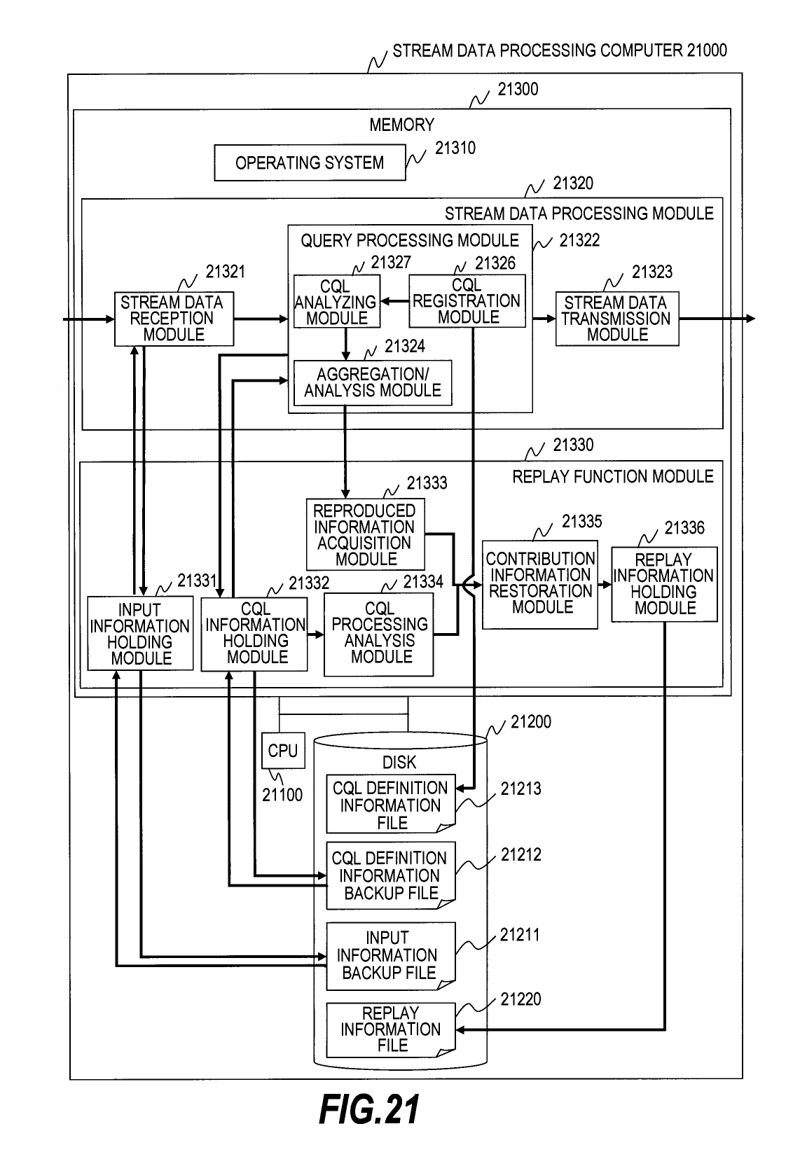

Next, the replay function is described. In an analysis scenario constituted by one or more queries, in the replay function, a stream data processing computer 21000 illustrated in FIG. 21 holds input information that has been input to the stream data processing computer 21000 illustrated in FIG. 21 in the past together with CQL definition information as backup data. In a case where a cause is determined with respect to a result of an arbitrary past, backup data of input information is input again to the stream data processing computer 21000 illustrated in FIG. 21, and data at a time point at which the result for which the cause thereof is to be determined is output is reproduced. Further, the stream data processing computer 21000 illustrated in FIG. 21 traces a processing history of a query from which the result for which the cause thereof is to be determined is output to acquire input information that contributed to the result for which the cause thereof is to be determined, and provides, to a client, the input information that contributed to the result.

The configuration of a stream data processing system having the replay function is the same as the configuration of the stream data processing system having the trace function, and description thereof is therefore omitted.

In addition, a data transmission computer 1100 and a result reception computer 1300 of the stream data processing system having the replay function are the same as the data transmission computer 1100 and the result reception computer 1300 of the stream data processing system having the trace function, and description thereof is therefore omitted.

Referring to FIG. 2, the join query model is described, and input information and processing contents of queries are the same as those of the first embodiment, and description thereof is therefore omitted.

Hereinbelow, description is given mainly of differences from the first embodiment.

FIG. 21 is a block diagram illustrating a configuration of the stream data processing computer 21000 having the replay function according to a second embodiment of this invention.

The stream data processing computer 21000 includes a CPU 21100, a DISK 21200, and a memory 21300.

The CPU 21100 executes a program loaded on the memory 21300.

The DISK 21200 stores data used by the program on the memory 21300. Specifically, the DISK 21200 stores an input information backup file 21211, a CQL definition information backup file 21212, a CQL definition information file 21213, and a replay information file 21220.

The input information backup file 21211 is a file in which backup data of input information that has been input to the stream data processing computer 21000 in the past is stored.

The CQL definition information backup file 21212 is a file in which backup data of CQL definition information that has been used in the stream data processing computer 21000 in the past is stored.

The replay information file 21220 is a file in which input information that contributed to a result output in the past is stored.

In the CQL definition information file 21213, CQL definition information that is defined in advance is stored.

The memory 21300 stores the program executed by the CPU 21100 and data necessary to execute the program. Specifically, the memory 21300 includes an operating system 21310, and a stream data processing module 21320 and a replay function module 21330 that are programs operated on the operating system 21310.

The stream data processing module 21320 processes stream data. Further, the stream data processing module 21320 includes a stream data reception module 21321, a query processing module 21322, and a stream data transmission module 21323.

The stream data reception module 21321 receives stream data transmitted from an external computer such as the data transmission computer 1100. The received stream data is output to the query processing module 21322 and an input information holding module 21331 of the replay function module 21330. Further, the stream data reception module 21321 outputs, to the query processing module 21322, input information that is input from the input information holding module 21331.

The stream data transmission module 21323 transmits a result output from the query processing module 21322 to an external computer such as the result reception computer 1300.

The query processing module 21322 analyzes the received stream data. The query processing module 21322 includes an aggregation/ analysis module 21324, a CQL registration module 21326, and a CQL analyzing module 21327.

The aggregation/analysis module 21324 aggregates and analyzes the stream data received by the stream data reception module 21321 according to a designated scenario that is input from the CQL analyzing module 21327. Further, the aggregation/analysis module 21324 executes processing for reproducing information that contributed to a result of a certain past.

The reproduced information that contributed to the result of the certain past includes input information, and an intermediate result and a result that are obtained with the use of a query.

The CQL registration module 21326 reads CQL definition information from the CQL definition information file 21213, and outputs the read CQL definition information to the CQL analyzing module 21327.

The CQL analyzing module 21327 analyzes the CQL definition information that is input from the CQL registration module 21326, and outputs, to the aggregation/ analysis module 21324, information that defines stream data and processing of queries.

The replay function module 21330 identifies input information that contributed to a result output in the past. The replay function module 21330 includes the input information holding module 21331, a CQL information holding module 21332, a reproduced information acquisition module 21333, a CQL processing analysis module 21334, a contribution information restoration module 21335, and a replay information holding module 21336.

The input information holding module 21331 executes two kinds of processing.

In the first processing, the input information holding module 21331 stores, in the input information backup file 21211, input information that is input from the stream data reception module 21321. Accordingly, backup data of the input information that is input to the stream data processing computer 21000 can be acquired.

In the second processing, in a case where a result of a certain past is reproduced, the input information holding module 21331 reads the backup data of the input information stored in the input information backup file 21211, and outputs the read backup data to the stream data reception module 21321.

The CQL information holding module 21332 executes three kinds of processing.

In the first processing, the CQL information holding module 21332 stores, in the CQL definition information backup file 21212, CQL definition information used for an analysis scenario, which is input from the query processing module 21322. Accordingly, obtain backup of the CQL definition information can be acquired.

In the second processing, in the case where the result of the certain past is reproduced, the CQL information holding module 21332 reads the backup data of the CQL definition information stored in the CQL definition information backup file 21212, and outputs the read backup data to the aggregation/analysis module 21324.

In the third processing, in the case where the result of the certain past is reproduced, the CQL information holding module 21332 reads the backup data of the CQL definition information stored in the CQL definition information backup file 21212, and outputs the read backup data to the CQL processing analysis module 21334.

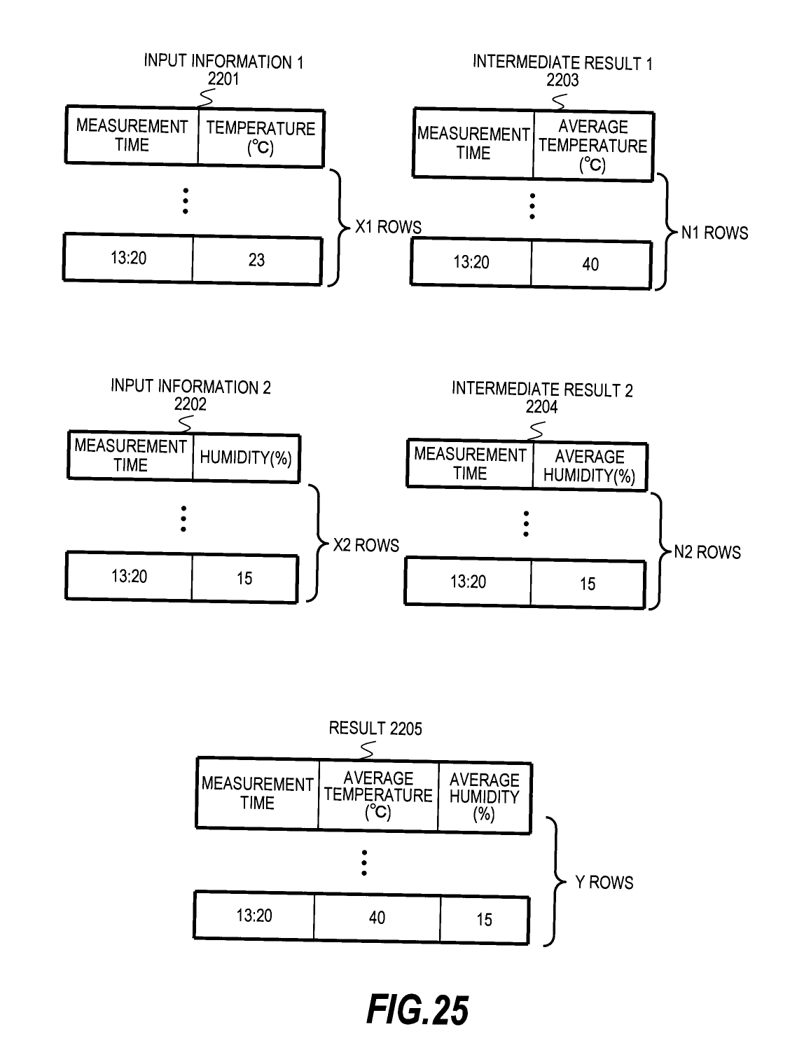

The query processing module 21322 executes processing with the use of the information input from the input information holding module 21331 and the CQL information holding module 21332 (backup data of the input information stored in the input information backup file 21211 and backup data of the CQL definition information stored in the CQL definition information backup file 21212), to thereby generate reproduced information that contributed to the result of the certain past. The reproduced information that contributed to the result of the certain past is arranged in the memory 21300. It should be noted that an example of the reproduced information that contributed to the result of the certain past is described later referring to FIG. 25.

The reproduced information acquisition module 21333 acquires, from the aggregation/analysis module 21324, the reproduced information that contributed to the result of the certain past. Further, the reproduced information acquisition module 21333 outputs, to the contribution information restoration module 21335, the reproduced information that contributed to the result of the certain past.

The CQL processing analysis module 21334 analyzes processing of the CQL based on the CQL definition information input from the CQL information holding module 21332. The CQL processing analysis module 21334 outputs, to the contribution information restoration module 21335, a result of the analysis of the processing of the CQL.

The contribution information restoration module 21335 restores input information that contributed to the result of the certain past based on the reproduced information that contributed to the result of the certain past, which is input from the reproduced information acquisition module 21333 (input information, intermediate result, and result), and the result of the analysis of the processing of the CQL, which is input from the CQL processing analysis module 21334. The contribution information restoration module 21335 then outputs, to the replay information holding module 21336, the result and the input information that contributed to the result.

The replay information holding module 21336 stores, in the replay information file 21220, the result and the input information that contributed to the result.

Description is given below of specific processing procedures executed by the stream data processing computer 21000 having the replay function. The replay function is used in a case where the stream data reception module 21321 receives input information from an external computer and a normal analysis scenario is executed (case of normal operation), and in a case where a causal analysis is executed with respect to a result of a past (case of causal analysis). First, the case of normal operation is described.

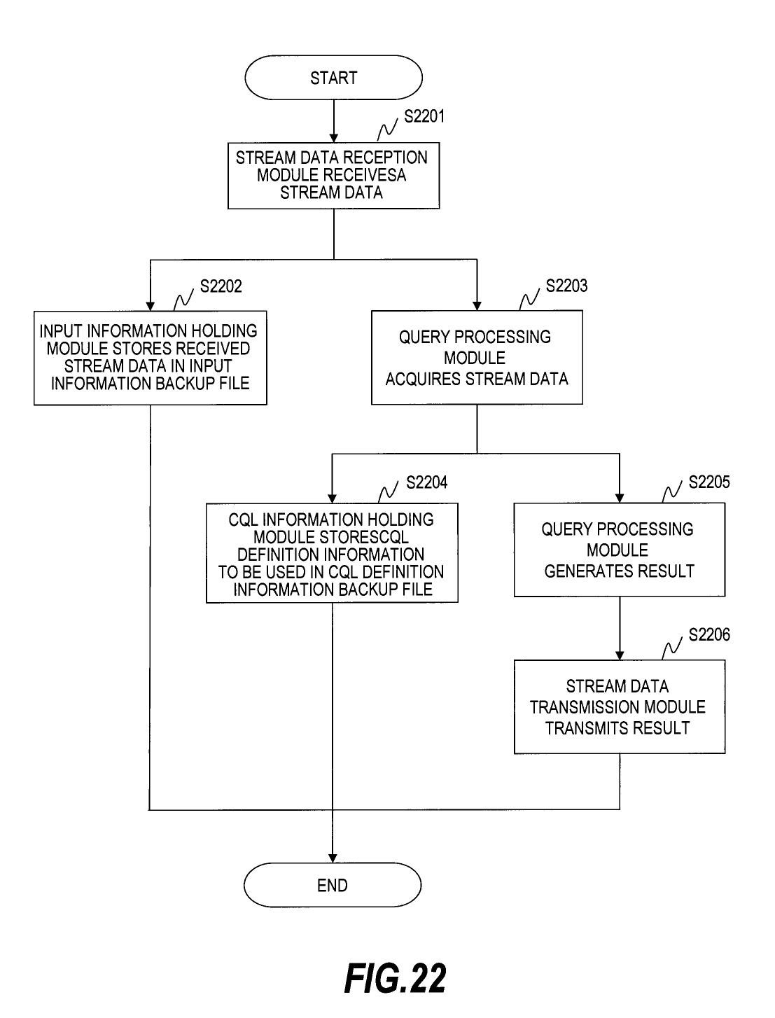

FIG. 22 is a flow chart illustrating processing executed by the stream data processing computer 21000 in the case of normal operation according to the second embodiment of this invention.

The stream data reception module 21321 receives stream data from an external computer (not shown) (Step S2201). The received stream data is output to each of the query processing module 21322 and the input information holding module 21331.

The input information holding module 21331 stores the stream data input from the stream data reception module 21321 in the input information backup file 21211 (Step S2202).

The query processing module 21322 acquires the stream data from the stream data reception module 21321 (Step S2203).

The CQL information holding module 21332 acquires CQL definition information to be used from the query processing module 21322, and stores the acquired CQL definition information in the CQL definition information backup file 21212 (Step S2204).

The query processing module 21322 uses the stream data input from the stream data reception module 21321 to generate a result (Step S2205). The generated result is output to the stream data transmission module 21323.

The stream data transmission module 21323 transmits the result input from the query processing module 21322 to an external computer (not shown) (Step S2206).

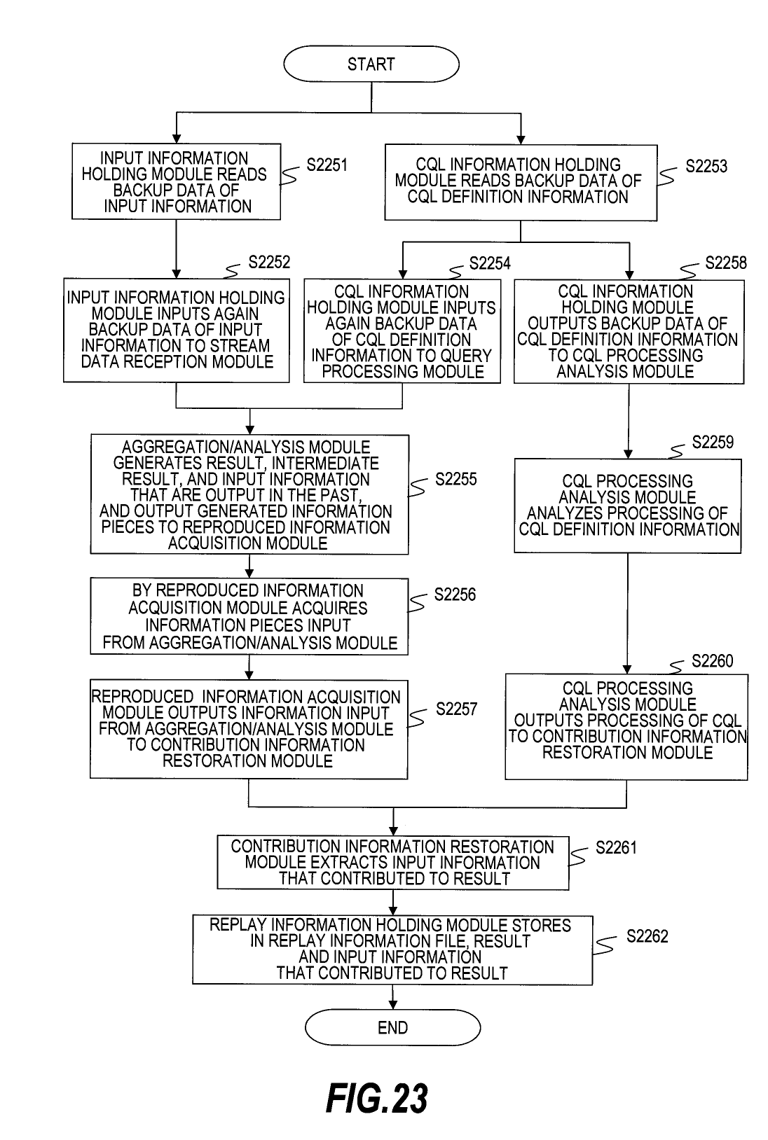

Next, referring to FIG. 23, description is given of processing executed in the case of causal analysis.

FIG. 23 is a flow chart illustrating processing executed by the stream data processing computer 21000 in the case of causal analysis according to the second embodiment of this invention.

The execution of the causal analysis is started by, for example, an instruction given from a user of the outside (not shown).

The input information holding module 21331 reads backup data of input information from the input information backup file 21211 (Step S2251), and outputs the read backup data of the input information to the stream data reception module 21321 (Step S2252).

The CQL information holding module 21332 reads backup data of CQL definition information from the CQL definition information backup file 21212 (Step S2253).

The CQL information holding module 21332 outputs the read backup data of the CQL definition information to the query processing module 21322 (Step S2254), and outputs the read backup data of the CQL definition information to the CQL processing analysis module 21334 (Step S2258).

The aggregation/analysis module 21324 uses the input backup data of the input information and the input backup data of the CQL definition information to generate a result, an intermediate result, and input information that are output in the past, and outputs the generated information pieces to the reproduced information acquisition module 21333 (Step S2255). Examples of the generated information pieces are described later referring to FIG. 25.

The reproduced information acquisition module 21333 acquires the information pieces (result, intermediate result, and input information that are output in the past) input from the aggregation/analysis module 21324 (Step S2256), and outputs the acquired information pieces (result, intermediate result, and input information that are output in the past) to the contribution information restoration module 21335 (Step S2257).

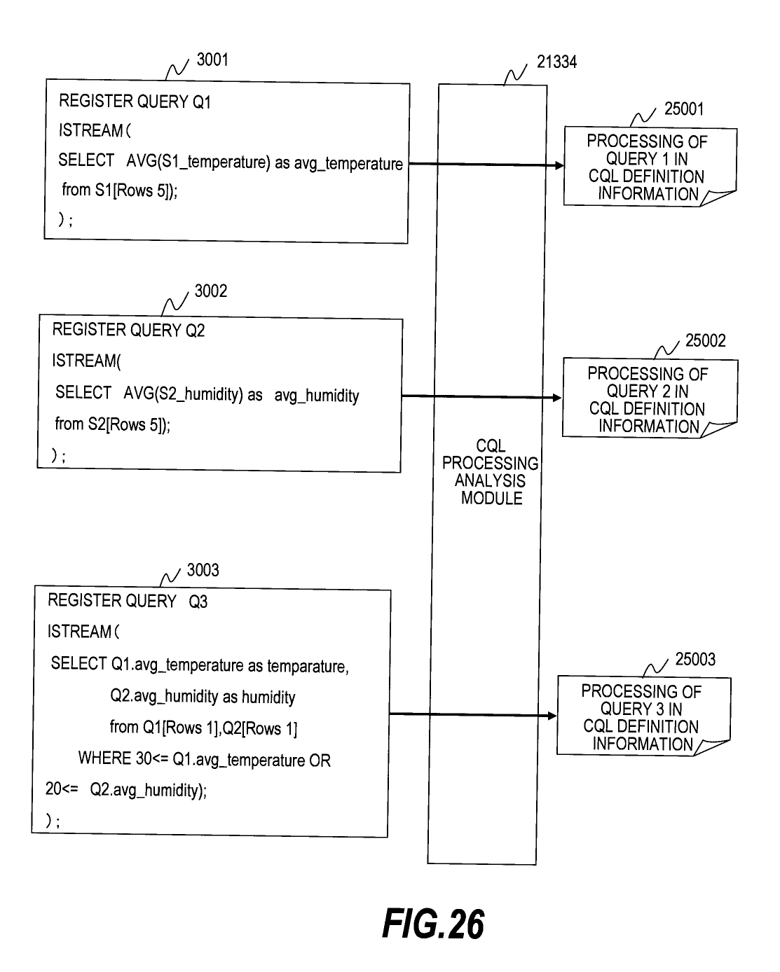

The CQL processing analysis module 21334 analyzes processing of the CQL definition information based on the backup data of the CQL definition information that is input from the CQL information holding module 21332 (Step S2259), and outputs a result of the analysis to the contribution information restoration module 21335 (Step S2260). It should be noted that an example of the processing of Step S2259 is described later referring to FIG. 26.

The contribution information restoration module 21335 extracts input information that contributed to the result output in the past, based on the result, the intermediate result, and the input information that are output in the past and input from the reproduced information acquisition module 21333, and the processing of the CQL definition information that is input from the CQL processing analysis module 21334 (Step S2261). The result output in the past and the input information that contributed to the result are output to the replay information holding module 21336.

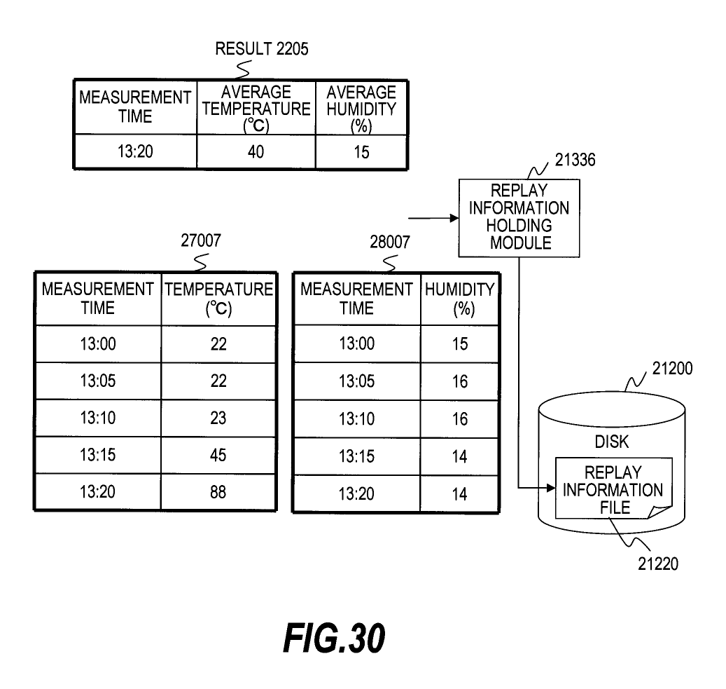

The replay information holding module 21336 stores, in the replay information file 21220, the result output in the past and the input information that contributed to the result, which are input from the contribution information restoration module 21335 (Step S2262). An example of the processing of Step S2262 is described later referring to FIG. 30.

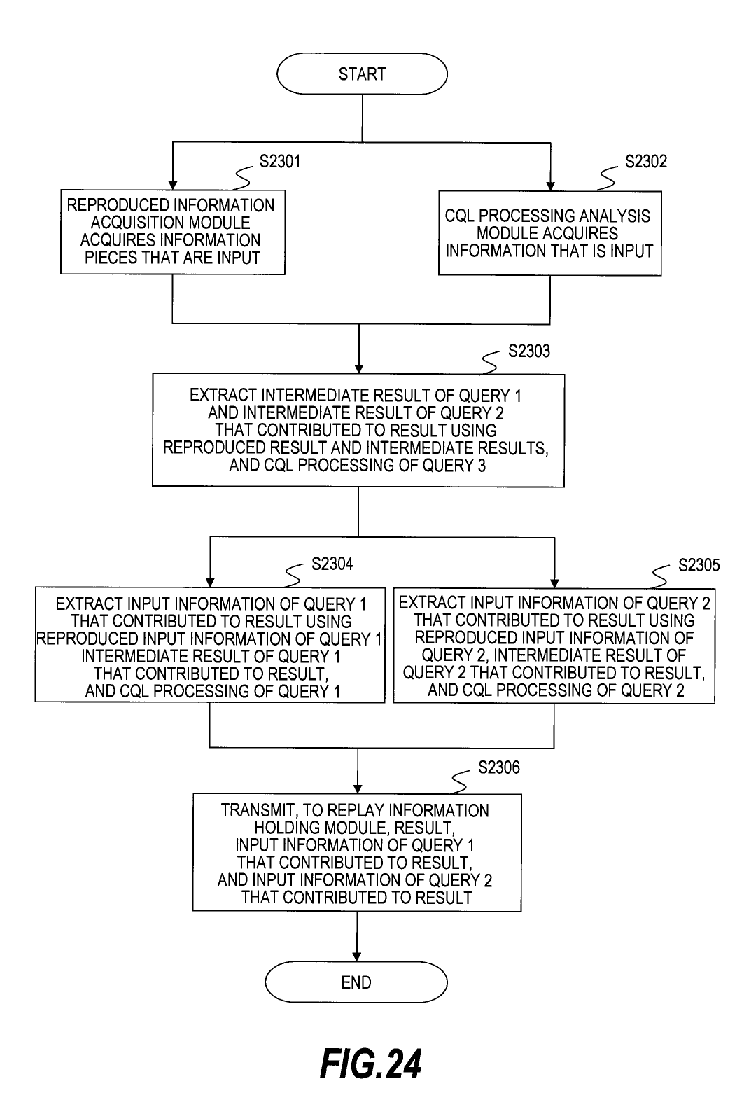

FIG. 24 is a flow chart illustrating an example of processing executed by the contribution information restoration module 21335 according to the second embodiment of this invention.

First, the reproduced information acquisition module 21333 acquires the information pieces (result, intermediate result, and input information that are output in the past) input from the aggregation/analysis module 21324 (Step S2301), and the CQL processing analysis module 21334 acquires pieces of the backup data of the CQL definition information that are input from the CQL information holding module 21332 (Step S2302).

Hereinbelow, description is given of the information pieces acquired by the reproduced information acquisition module 21333 and the CQL processing analysis module 21334, and information pieces output by the reproduced information acquisition module 21333 and the CQL processing analysis module 21334.

The information pieces input from the aggregation/analysis module 21324 specifically include the input information 1 (2201), the input information 2 (2202), the intermediate result 1 (2203), the intermediate result 2 (2204), and the result 2205. It should be noted that the above-mentioned information pieces are information pieces reproduced by the aggregation/analysis module 21324.

FIG. 25 is an explanatory diagram illustrating an example of information pieces output from the aggregation/analysis module 21324 to the reproduced information acquisition module 21333 according to the second embodiment of this invention.

The information pieces output from the aggregation/analysis module 21324 to the reproduced information acquisition module 21333 include the input information 1 (2201), the input information 2 (2202), the intermediate result 1 (2203), the intermediate result 2 (2204), and the result 2205.

In the example illustrated in FIG. 25, the input information 1 (2201) is a table [measurement time, temperature] having X1 rows. The input information 2 (2202) is a table [measurement time, humidity, pressure] having X2 rows.

Further, the intermediate result 1 (2203) is a table [measurement time, average temperature] having N1 rows. The intermediate result 2 (2204) is a table [measurement time, average humidity] having N2 rows.

Further, the result 2205 is a table [measurement time, average temperature, average humidity] having Y rows.

The pieces of the backup data of the CQL definition information that are input from the CQL information holding module 21332 specifically include the CQL definition information 3003, the CQL definition information 3004, and the CQL definition information 3005.

Processing of the CQL definition information output from the CQL processing analysis module 21334 specifically include processing 25001 of the CQL definition information of the query 1 (2101) illustrated in FIG. 26, processing 25002 of the CQL definition information of the query 2 (2102) illustrated in FIG. 26, and processing 25003 of the CQL definition information of the query 3 (2103) illustrated in FIG. 26.

FIG. 26 is an explanatory diagram illustrating an example of information output from the CQL processing analysis module 21334 to the contribution information restoration module 21335 according to the second embodiment of this invention.

As illustrated in FIG. 26, the CQL definition information 3003 of the query 1 (2101), the CQL definition information 3004 of the query 2 (2102), and the CQL definition information 3005 of the query 3 (2103) are input to the CQL processing analysis module 21334.

The CQL processing analysis module 21334 analyzes the input CQL definition information 3003, CQL definition information 3004, and CQL definition information 3005, and outputs the processing of the CQL definition information.

In the example illustrated in FIG. 26, the CQL definition information 3003 is analyzed and the processing 25001 of the CQL definition information of the query 1 (2101) is output. Further, the CQL definition information 3004 is analyzed and the processing 25002 of the CQL definition information of the query 2 (2102) is output. Still further, the CQL definition information 3005 is analyzed and the processing 25003 of the CQL definition information of the query 3 (2103) is output.

Hereinabove, the description is given of the information pieces acquired by the reproduced information acquisition module 21333 and the CQL processing analysis module 21334, and the information pieces output by the reproduced information acquisition module 21333 and the CQL processing analysis module 21334.

The processing illustrated in FIG. 24 is described again.

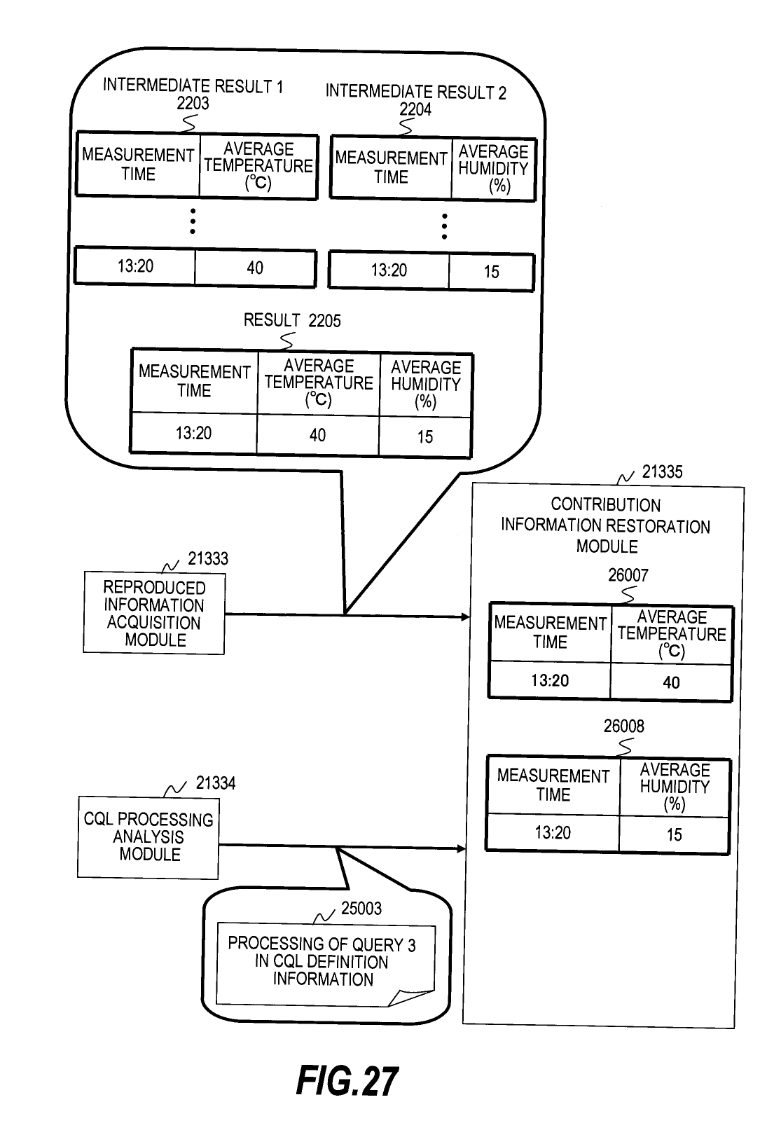

The contribution information restoration module 21335 extracts the intermediate result 1 (2203) and the intermediate result 2 (2204) that contributed to the result 2205 based on the result 2205, the intermediate result 1 (2203), and the intermediate result 2 (2204) that are input from the reproduced information acquisition module 21333, and the processing 25003 of the CQL definition information of the query 3 (2103) that is input from the CQL processing analysis module 21334 (Step S2303). It should be noted that an example of the processing of Step S2303 is described later referring to FIG. 27.

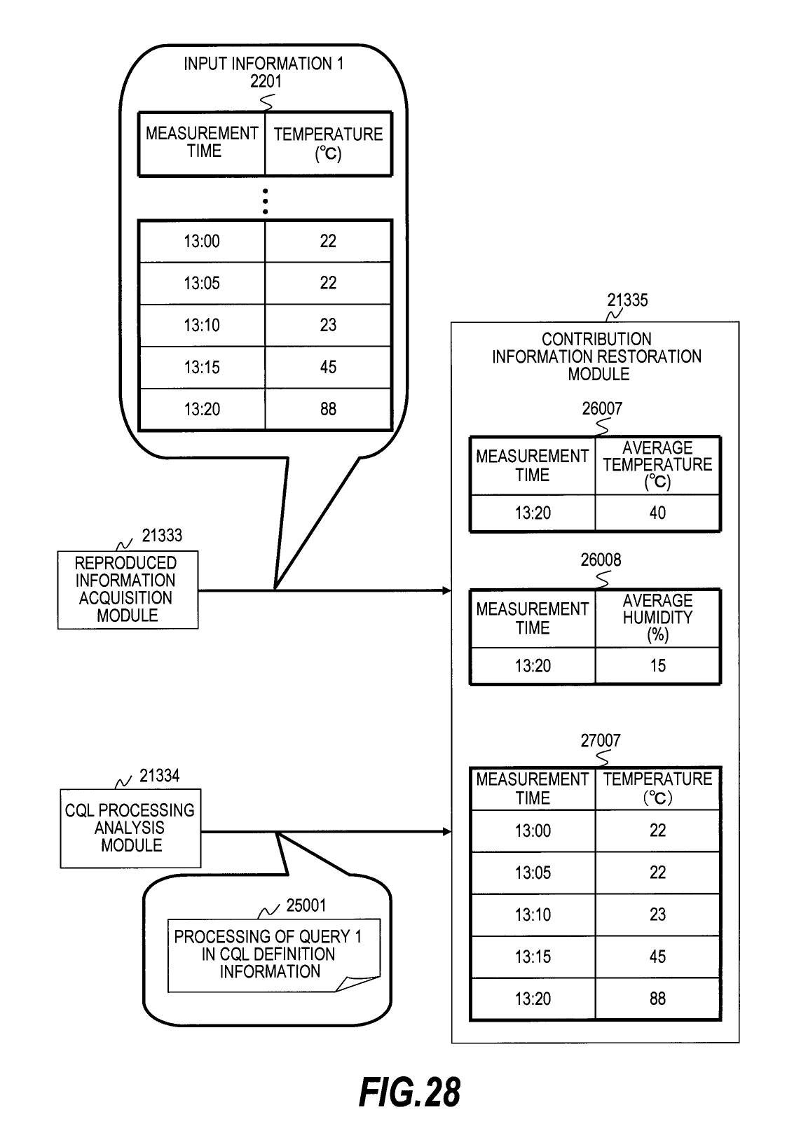

The contribution information restoration module 21335 extracts input information of the query 1 (2101) that contributed to the result 2205 based on the input information 1 (2201) that is input from the reproduced information acquisition module 21333, the processing 25001 of the CQL definition information of the query 1 (2101) that is input from the CQL processing analysis module 21334, and the intermediate result 1 (2203) that contributed to the result 2205 and is extracted in Step S2303 (Step S2304). It should be noted that an example of the processing of Step S2304 is described later referring to FIG. 28.

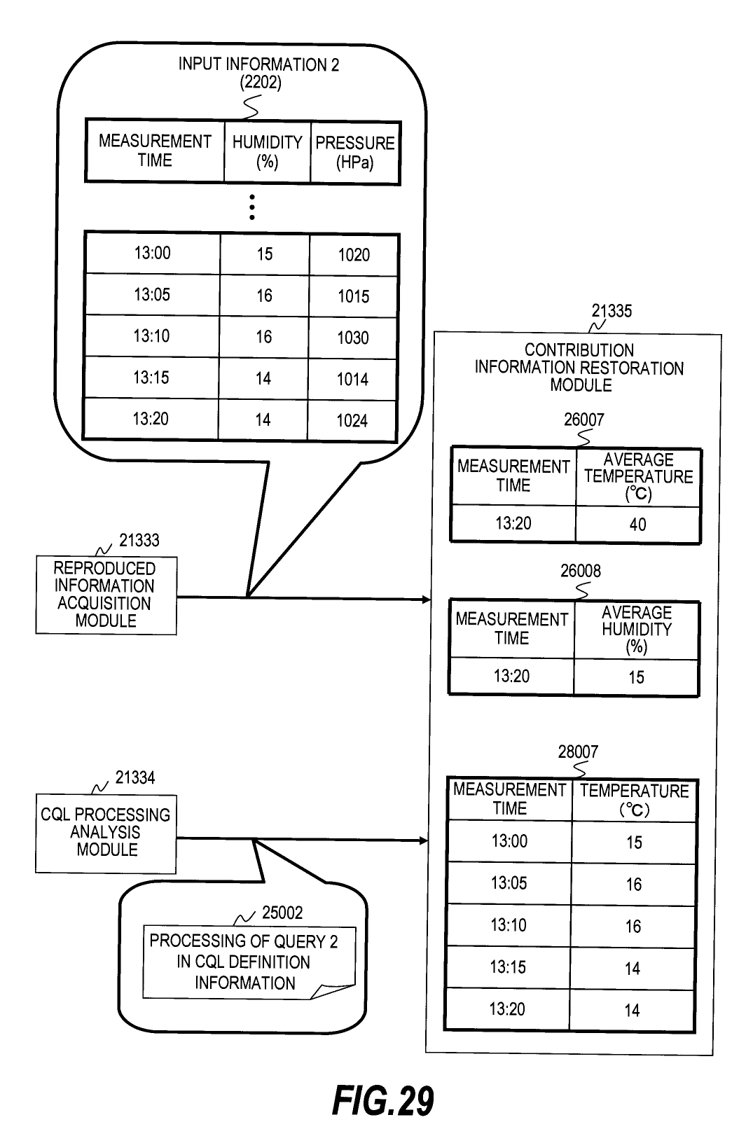

The contribution information restoration module 21335 extracts input information of the query 2 (2102) that contributed to the result 2205 based on the input information 2 (2202) that is input from the reproduced information acquisition module 21333, the processing 25002 of the CQL definition information of the query 2 (2102) that is input from the CQL processing analysis module 21334, and the intermediate result 2 (2204) that contributed to the result 2205 and is extracted in Step S2303 (Step S2305). It should be noted that an example of the processing of Step S2305 is described later referring to FIG. 29.

The contribution information restoration module 21335 outputs, to the replay information holding module 21336, the result 2205, the input information of the query 1 (2101) that contributed to the result 2205, and the input information of the query 2 (2102) that contributed to the result 2205 (Step S2306).

Hereinbelow, description is given of an example of a series of processing executed in the stream data processing computer 21000 having the replay function. It should be noted that the description is given by taking the join query model illustrated in FIG. 2 as an example.

FIG. 27 is an explanatory diagram illustrating an example of processing of extracting an intermediate result of the query 1 (2101) and an intermediate result of the query 2 (2102) that contributed to the result 2205, which is executed by the contribution information restoration module 21335 according to the second embodiment of this invention.

As illustrated in FIG. 27, the intermediate result 1 (2203), the intermediate result 2 (2204), and the result 2205 are input from the reproduced information acquisition module 21333 to the contribution information restoration module 21335. Further, the processing 25003 of the CQL definition information of the query 3 (2103) is input from the CQL processing analysis module 21334 to the contribution information restoration module 21335.

The contribution information restoration module 21335 extracts an intermediate result 26007 of the query 1 (2101) and an intermediate result 26008 of the query 2 (2102) that contributed to the result 2205 based on the information pieces thus input.

FIG. 28 is an explanatory diagram illustrating an example of processing of extracting input information that contributed to the intermediate result 26007 of the query 1 (2101), which is executed by the contribution information restoration module 21335 according to the second embodiment of this invention.

As illustrated in FIG. 28, the input information 1 (2201) is input from the reproduced information acquisition module 21333 to the contribution information restoration module 21335. Further, the processing 25001 of the CQL definition information of the query 1 (2101) is input from the CQL processing analysis module 21334 to the contribution information restoration module 21335.

The contribution information restoration module 21335 extracts input information 27007 that contributed to the intermediate result 26007 of the query 1 (2101) based on the information pieces thus input.

FIG. 29 is an explanatory diagram illustrating an example of processing of extracting input information that contributed to the intermediate result 26008 of the query 2 (2102), which is executed by the contribution information restoration module 21335 according to the second embodiment of this invention.

As illustrated in FIG. 29, the input information 2 (2202) is input from the reproduced information acquisition module 21333 to the contribution information restoration module 21335. Further, the processing 25002 of the CQL definition information of the query 2 (2102) is input from the CQL processing analysis module 21334 to the contribution information restoration module 21335.

The contribution information restoration module 21335 extracts input information 28007 that contributed to the intermediate result 26008 of the query 2 (2102) based on the information pieces thus input.

FIG. 30 is an explanatory diagram illustrating an example of processing executed by the replay information holding module 21336 according to the second embodiment of this invention.

The replay information holding module 21336 stores, in the replay information file 21220 of the DISK 21200, the result 2205, the input information 27007 that contributed to the result 2205, and the input information 28007 that contributed to the result 2205, which are input from the contribution information restoration module 21335.

According to the second embodiment of this invention, the stream data processing computer 21000 holds in advance the input information that is input to the stream data processing computer 21000, together with the CQL definition information, to thereby identify the input information that contributed to the result. Accordingly, the cause of the result can be analyzed.

This invention is useful when applied to analyses of, for example, illegal trading of stocks for stock price manipulation in a financial field and a cause of error log issuance in computer system management.

While the present invention has been described in detail and pictorially in the accompanying drawings, the present invention is not limited to such detail but covers various obvious modifications and equivalent arrangements, which fall within the purview of the appended claims.

What is claimed is:

1. A computer system for processing stream data, in which a plurality of queries that are set in advance are executed by using first stream data that arrives successively, to thereby output a result,
the computer system comprising a stream data processing computer that comprises a processor and a memory connected to the processor and processes the first stream data:
wherein the first stream data includes a plurality of pieces of input information;
wherein the plurality of queries includes a first query, a second query and a third query;
based on the first stream data, the first query is executed to output a first intermediate result, and the second query is executed to output a second intermediate result;
the third query is executed with inputting the first intermediate result and the second intermediate result to output the result; and
the computer system is configured to:
hold processing executed by the first query, the second query and the third query;
extract first contribution information including part of the first stream data contribute to the first intermediate result based on the first stream data and processing executed by the first query;
extract second contribution information including part of the first stream data contribute to the second intermediate result based on the first stream data and processing executed by the second query;
extract third contribution information including part of the first stream data contribute to the result based on the first contribution input information and the second contribution input information; and
hold relation between the result and the third contribution information.

2. The computer system according to claim 1, which is further configured to hold CQL definition information including processing executed by each of the queries, wherein
the CQL definition information includes a window operator for extracting the input information to be processed by the each of the queries from the first stream data, and
the computer system extracts a predetermined number of pieces of the input information that contributed to the result from the input information based on the CQL definition information.

3. The computer system according to claim 2, further comprising:
a contribution information extraction module for extracting the third contribution information;
a contribution information addition module for adding the extracted third contribution information to the result; and
a trace information holding module for holding trace information including the result to which the third contribution information is added.

4. The computer system according to claim 3, wherein:
the input information includes a plurality of data columns;
the each of the queries included in the CQL definition information further includes an instruction to extract one of the plurality of data streams that is actually necessary for the each of the queries from the extracted predetermined number of pieces of the input information; and
the contribution information extraction module extracts, based on the instruction to extract the one of the plurality of data columns that is actually necessary for the each of the plurality of queries, from the input information, a data column that contributes to the first intermediate result as the first contribution information, a data column that contributes to the second intermediate result as the second contribution information, and a data column that contributes to the result as the third contribution information.

5. The computer system according to claim 4, wherein:
the contribution information addition module adds the extracted first contribution information to the first intermediate result, and the extracted second contribution information to the second intermediate result; and
the trace information holding module holds, as the trace information, the first intermediate result to which the first contribution information is added, and the second intermediate result to which the second contribution information is added.

6. The computer system according to claim 3, further comprising a contribution information removal module for removing the third contribution information that is added to the result, and outputting the result from which the third contribution information is removed.

7. The computer system according to claim 2, further comprising:
an input information holding module for holding, as second stream data, the first stream data that is input in a past;
a CQL definition information holding module for holding the CQL definition information;
a CQL processing analysis module for analyzing the CQL definition information obtained from the CQL definition information holding module;
a query processing module for one of executing the each of the queries to output the result based on the first stream data, and executing the each of the queries to reproduce the result, the first intermediate result and the second intermediate result based on the second stream data held by the input information holding module and the CQL definition information held by the CQL definition information holding module;
a reproduced information obtaining module for obtaining the reproduced result, the reproduced first intermediate result and the reproduced second intermediate result;
a contribution information restoration module for extracting the third contribution information based on a result of the analysis of the CQL definition information, the second stream data, the reproduced result, the reproduced first intermediate result and the reproduced second intermediate result; and
a replay information holding module for holding the result and the third contribution information in association with each other as replay information.

8. The computer system according to claim 7, wherein:
the input information includes a plurality of data columns;
the each of the queries included in the CQL definition information further includes an instruction to extract one of the plurality of data columns that is actually necessary for the each of the queries from the extracted predetermined number of pieces of the input information; and
the contribution information restoration module is configured to:
extract a data column that contributed to the first intermediate result as the first contribution information from the input information based on the input information to be processed by the each of the queries and the result of the analysis of the each of the queries included in the CQL definition information; and
extract a data column that contributed to the second intermediate result as the second contribution information from the input information based on the input information to be processed by the each of the queries and the result of the analysis of the each of the queries included in the CQL definition information.

9. The computer system according to claim 8, wherein the contribution information restoration module is configured to extract a data column that contributed to the result as the third contribution information from the input information based on the result of the analysis of the first query included in the CQL definition information, the result of the analysis of the second query included in the CQL definition information, the extracted first contribution information and the extracted second contribution information.

10. The computer system according to claim 7, wherein:
the query processing module is configured to:
obtain the second stream data from the input information holding module;
obtain the result of the analysis of the CQL definition information from the CQL processing analysis module; and
reproduce the result, the first intermediate result and the second intermediate result in the memory based on the obtained second stream data and the obtained result of the analysis of the CQL definition information; and
the reproduced information obtaining module obtains the result, the first intermediate result and the second intermediate result that are reproduced in the memory.

11. A stream data processing method executed by a computer system in which queries that are set in advance are executed by using first stream data that arrives successively, to thereby output a result,
the computer system having a stream data processing computer that has a processor and a memory connected to the processor and processes the first stream data,
the first stream data including a plurality of pieces of input information,
the plurality of queries including a first query, a second query and a third query,
based on the first stream data, the first query being executed to output a first intermediate result, and the second query being executed to output a second intermediate result,
based on the first intermediate result and the second intermediate result, the third query being executed with inputting the first intermediate result and the second intermediate result to output the result, and
the stream data processing method including the steps of:
holding processing of the first query, the second query and the third query;
extracting first contribution information including part of the first stream data contribute to the first intermediate result based on the first stream data and processing executed by the first query;
extracting second contribution information including part of the first stream data contribute to the first intermediate result based on the first stream data and processing executed by the first query;
extracting third contribution information including part of the first stream data contribute to the result based on the first contribution information and the second contribution information; and
holding relation between the result and the third contribution information.

12. The stream data processing method according to claim 11, wherein:
the computer system holds, CQL definition information including processing executed by each of the queries;
the CQL definition information includes a window operator for extracting the input information to be processed by the each of the queries from the first stream data, and
the stream data processing method further includes the step of extracting a predetermined number of pieces of the input information that contributed to the result from the input information based on the CQL definition information.

13. The stream data processing method according to claim 12, further including the steps of:
extracting the third contribution information;
adding the extracted third contribution information to the result; and
holding, as trace information including the result to which the third contribution information is added.

14. The stream data processing method according to claim 12, further including the steps of:
executing the queries;
holding, as second stream data, the first stream data that is input in a past;
holding the CQL definition information;
analyzing the CQL definition information;
reproducing the result, the first intermediate result and the second intermediate result based on the second stream data and a result of the analysis of the CQL definition information;
obtaining the reproduced result, the reproduced first intermediate result and the reproduced second intermediate result;
extracting the third contribution information based on the result of the analysis of the CQL definition information, the second stream data, the reproduced result, the reproduced first intermediate result and the reproduced second intermediate result; and
holding the result and the third contribution information in association with each other as replay information.

15. A machine readable medium containing at least one sequence of instructions executed in by a computer system in which queries that are set in advance are executed by using first stream data that arrives successively, to thereby output a result,
the computer system having a stream data processing computer that has a processor and a memory connected to the processor, and processes the first stream data,
the first stream data including a plurality of pieces of input information,
the plurality of queries including a first query, a second query and a third query,
based on the first stream data, the first query being executed to output a first intermediate result, and the second query being executed to output a second intermediate result,
based on the first intermediate result and the second intermediate result, the third query being executed with inputting the first intermediate result and the second intermediate result to output the result, and
the instructions, when executed, causing computer system to:
hold processing of the first query, the second query, and the third query;
extract first contribution information including part of the first stream data contribute to the first intermediate result based on the first stream data and the processing executed by the first query;
extract second contribution information including part of the first stream data contribute to the first intermediate result based on the first stream data and processing executed by the first query;
extract third contribution information including part of the first stream data contribute to the result based on the first contribution information and the second contribution information; and
hold relation between the result and the third contribution information.

16. The machine readable medium according to claim 15, wherein:
the computer system holds CQL definition information including processing executed by each of the queries;
the CQL definition information includes a window operator for extracting the input information to be processed by the each of the queries from the first stream data, and
the instructions further causes computer system to extract a predetermined number of pieces of the input information that contributed to the result from the input information based on the CQL definition information.

17. The machine readable medium according to claim 16, wherein the instructions further causes computer system to:
extract the third contribution information;
add the extracted third contribution information to the result; and
hold, as trace information including the result to which the third contribution information is added.

18. The machine readable medium according to claim 16, wherein the instructions further causes computer system to:
hold, as second stream data, the first stream data that is input in a past;
hold the CQL definition information;
analyze the CQL definition information;
reproduce, the result, the first intermediate result, and the second intermediate result based on the second stream data and a result of the analysis of the CQL definition information;
obtain the reproduced result, the reproduced first intermediate result and the reproduced second intermediate result;
extract the third contribution information based on the result of the analysis of the CQL definition information, the second stream data, the reproduced result, the reproduced first intermediate result and the reproduced second intermediate result; and
hold the result and the third contribution information in association with each other as replay information.
